(19) United States
(12) Patent Application Publication
(10) Pub. No.: US 2012/0158935 A1
(43) Pub. Date: Jun. 21, 2012

(54) METHOD AND SYSTEMS FOR MANAGING SOCIAL NETWORKS

(75) Inventors: Toyoaki Kishimoto, San Diego, CA (US); Michael Chang, San Diego, CA (US); Andrew Lee Lawton, San Marcos, CA (US); Gary Robert Lyons, San Diego, CA (US); Sean Patrick Kennedy, San Diego, CA (US); Rommel M. Garay, San Marcos, CA (US); Edward Theodore Winter, San Diego, CA (US); Fredrik Carpio, Menifee, CA (US); Adrian Crisan, San Diego, CA (US)

(73) Assignee: Sony Corporation

(21) Appl. No.: 12/974,805

(22) Filed: Dec. 21, 2010

(51) Int. Cl. G06F 15/173

(52) U.S. Cl. 709/223

(57) ABSTRACT

Systems and methods consistent with the disclosure relate to managing social networks. According to one exemplary embodiment, a computer-implemented method for managing social networks of a user is disclosed. The method accesses an online social network site of the user, and receives, from the online social network site, networking content related to the user and a plurality of contacts of the user. The method identifies the plurality of contacts based on the networking content, and determines relationships between the user and the respective contacts based on the networking content. The method also creates a social networking map according to the relationships.

### TECHNICAL FIELD

The present disclosure relates to methods and systems for managing social networks. More particularly, the disclosure relates to methods and systems for creating, updating, and using social networking maps.

### BACKGROUND

Online social networking sites are widely used by users to make connections to new contacts and remain connected with their existing contacts. For example, a user may register for an account with an online social networking site, such as Facebook™, and post a profile of himself on the site so that other users may get to know him. The user may also post messages, photos, videos, or other files, on the site. The user may add other users on the same social networking site to his list of contacts, so that these contacts may view his posts on the site. For instance, the user may add people he knows in real life, such as his family members, relatives, and friends, to his list of contacts. Once a person is added as a contact, the user may be allowed to see the list of contacts of this person, and he may decide to add some of that person's contacts as his own contacts.

Given the large number of people one could potentially connect to on a social networking site, the user's list of contacts can grow rapidly. Furthermore, it is common for a user to have several social networking accounts on different social networking sites. For example, one may have both a Facebook™ and a LinkedIn™ account. With more networks, and more contacts per network, it becomes difficult to keep track of the networking content posted by all contacts, such as messages, articles, photos, videos, etc. In addition, since the contacts and networking content are maintained on the online sites, accessing the information requires Internet connections. Therefore, the information is not available to the user when he does not have access to the Internet.

Accordingly, there exists a need for an improved method and system for efficiently managing a user's online social networking contacts and content.

### SUMMARY

Systems and methods consistent with the disclosure relate to managing social networks. According to one exemplary embodiment, a computer-implemented method for managing social networks of a user is disclosed. The method accesses an online social network site of the user, and receives, from the online social network site, networking content related to the user and a plurality of contacts of the user. The method identifies the plurality of contacts based on the networking content, and determines relationships between the user and the respective contacts based on the networking content. The method also creates a social networking map according to the relationships.

According to another exemplary embodiment, a social network managing system is disclosed. The social network managing system comprises a processor. The processor is configured to access an online social network site of the user, and receive, from the online social network site, networking content related to the user and a plurality of contacts of the user. The processor is further configured to identify the plurality of contacts based on the networking content, and determine relationships between the user and the respective contacts based on the networking content. The processor is also configured to create a social networking map according to the relationships.

According to yet another exemplary embodiment, a non-transitory computer-readable storage device that stores a set of instructions which, when executed by a processor, performs a method for managing social networks of a user is disclosed. The method accesses an online social network site of the user, and receives, from the online social network site, networking content related to the user and a plurality of contacts of the user. The method identifies the plurality of contacts based on the networking content, and determines relationships between the user and the respective contacts based on the networking content. The method also creates a social networking map according to the relationships.

It is to be understood that both the foregoing general description and the following detailed description are exemplary and explanatory only and are not restrictive of the inventions, as claimed.

### BRIEF DESCRIPTION OF THE DRAWINGS

The accompanying drawings, which are incorporated in and constitute a part of this specification, illustrate several embodiments consistent with the disclosure and together with the description, serve to explain the principles of the inventions herein. In the drawings:

FIG. 1 illustrates an exemplary network including an exemplary social network managing system and its interactions with various online resources, consistent with the present invention;

FIG. 2 illustrates a block diagram of an exemplary social network managing system, consistent with the disclosure;

FIG. 3 illustrates a block diagram of an exemplary social network managing application, consistent with the disclosure;

FIG. 4 illustrates an exemplary user interface for a social network managing application, consistent with the disclosure;

FIG. 5 illustrates an exemplary family tree shown on an user interface, consistent with the present invention;

FIG. 6 illustrates an exemplary friends tree shown on an user interface, consistent with the present invention;

FIG. 7 illustrates function modules of an exemplary social network managing application, consistent with the disclosure;

FIG. 8 is an exemplary flow chart for creating a social networking map, consistent with the present invention;

FIG. 9 illustrates an exemplary family tree, consistent with the present invention;

FIG. 10 illustrates an exemplary friends tree, consistent with the present invention;

FIG. 11 is an exemplary flow chart for generating a social networking map based on photos, consistent with the present invention;

FIG. 12 is an exemplary flow chart for searching networking content according to a user query, consistent with the present invention;

FIG. 13 is an exemplary flow chart for sharing networking content on a repository, consistent with the present invention;

FIG. 14 is an exemplary flow chart for generating a Dropbox directory on a repository, consistent with the present invention;

FIG. 15 is an exemplary flow chart for tagging content and updating a social networking map, consistent with the present invention;

FIG. 16 is an exemplary flow chart for updating a social networking map based on new networking content, consistent with the present invention;

FIG. 17 is an exemplary flow chart for distributing content to contacts in a social networking map, consistent with the present invention;

FIG. 18 is an exemplary flow chart for merging content with a same tag, consistent with the present invention;

FIG. 19 is an exemplary flow chart for recording content and sending the content to contacts on a social networking map, consistent with the present invention;

FIG. 20 is an exemplary flow chart for sharing networking content during online chatting, consistent with the present invention;

FIG. 21 is an exemplary flow chart for creating a calendar or timeline view, consistent with the present invention;

FIG. 22 illustrates an exemplary calendar view created by the exemplary process of FIG. 21, consistent with the present invention;

FIG. 23 illustrates an exemplary timeline view created by the exemplary process of FIG. 21, consistent with the present invention;

FIG. 24 is an exemplary flow chart for decomposing networking content for providing feedback, consistent with the present invention;

FIG. 25 is an exemplary flow chart for managing friendship using a friends tree, consistent with the present invention;

FIG. 26 is an exemplary flow chart for generating a “tag cloud”, consistent with the present invention;

FIG. 27 is an exemplary flow chart for finding photos of a contact that are similar to photos of a user, consistent with the present invention;

FIG. 28 is an exemplary flow chart for sharing content with contacts featured in the content, consistent with the present invention;

FIG. 29 is an exemplary flow chart for sharing a video recorded during online chatting using a social networking map, consistent with the present invention;

FIG. 30 is an exemplary flow chart for updating a social networking map using information from a new social network account, consistent with the present invention;

FIG. 31 is an exemplary flow chart for finding content related to online chatting using a social networking map, consistent with the present invention; and

FIG. 32 is an exemplary flow chart for searching for content using a social networking map, consistent with the present invention.

### DESCRIPTION OF THE EMBODIMENTS

The following description refers to the accompanying drawings. Wherever possible, the same reference numbers will be used throughout the drawings to refer to the same or similar parts. While several exemplary embodiments and features of the disclosure are described herein, modifications, adaptations and other implementations are possible, without departing from the spirit and scope of the disclosure. For example, substitutions, additions or modifications may be made to the components illustrated in the drawings, and the exemplary methods described herein may be modified by substituting, reordering, or adding steps to the disclosed methods. Accordingly, the following detailed description does not limit the inventions. Instead, the proper scope of any claimed invention is defined by the appended claims.

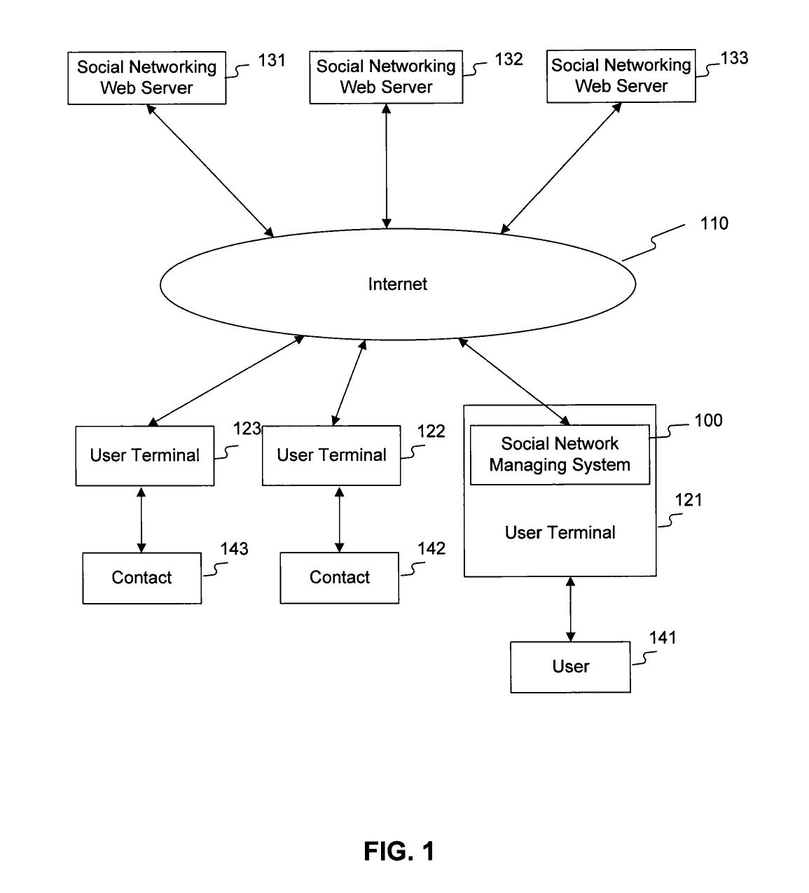

FIG. 1 illustrates an exemplary network including an exemplary social network managing system 100 and its interactions with various online resources, consistent with the present invention. Consistent with some embodiments, social network managing system 100, one or more user terminals, such as user terminals 121-123, and one or more social networking web servers, such as social networking web servers 131-133, may be coupled to Internet 110. For example, these devices may be connected to Internet 110 via a cable or wirelessly. It is contemplated that more or fewer user terminals and social networking web servers than those shown in FIG. 1 may be coupled to Internet 110.

A user terminal may be any electronic device that is accessible by a user. For example, each of user terminals 121-123 may be a terminal computer, such as a desktop or laptop, a smart phone, or a PDA. In some embodiments, user terminals 121-123 may access, via Internet 110, various online social networking sites maintained by social networking web servers 131-133. In some embodiments, different social networking sites may be designed for different networking purposes. For example, the social networking site available on social networking web server 131 may be designed for professional networking, such as for job hunting and career development, while the social networking site available on social networking web server 132 may be designed for personal networking, such as for dating, connection with classmates and alumni, or connection with people having same hobbies.

In some embodiments, user 141 may have a networking account with each social networking site and may access the site by confidential login information. User 141 may type in messages from user terminal 121 and post the messages on the social networking sites via Internet 110. User 141 may also upload files, such as photos, videos, audios, or text documents, from user terminal 121 to the social networking sites. Associated with each networking account, a social networking web server may store an account profile of the user, the networking content posted by the user, and a list of contacts the user makes through the respective networking site. For example, contacts 142 and 143 may be added by user 141 on one or more social networking sites.

In some embodiments, contact 142 may be user 141's family member or relative, and contact 143 may be user 141's friend. Contacts 142 and 143 may also access the various social networking sites via their own user terminals 122 and 123. Contacts 142 and 143 may view user 141's profile and access and download user 141's networking content. In some embodiments, contacts 142 and 143 may also post content, such as messages, photos, videos, etc., on user 141's web page via their user terminals 122 and 123. Such content may also be stored associated with user 141's networking account on the social networking web servers.

User 141 may use social network managing system 100 to manage his social networks on the social networking web sites. In some embodiments, social network managing system 100 may be a part of a user terminal, and share one or more hardware components with the user terminal. For example, user terminal 121 may be a laptop computer, and social network managing system 100 may be installed on user terminal 121 and use hardware components such as the processor, the memory, the hard drive, etc. of user terminal 121. In some other embodiments, social network managing system 100 may be external to the user terminal, and use hardware components independent from user terminal 121.

Social network managing system 100 may be configured to manage user 141's contacts (such as contacts 142 and 143), and networking content of user 141 and/or contacts 142 and 143 on one or more of social networking web servers 131-133. For example, social network managing system 100 may access the social networking web sites using user 141's login information, and retrieve data and/or files regarding user 141's social networking activities on the sites. In some embodiments, based on the retrieved data, social network managing system 100 may be configured to create a social networking map that includes user 141's contacts, such as contacts 142 and 143, from the various social networking web sites. Social network managing system 100 may also be configured to create a content repository for storing the networking content retrieved from the social networking web sites.

In some embodiments, social network managing system 100 may be configured to communicate with user terminals 122 and 123 used by contacts 142 and 143, respectively. For example, social network managing system 100 may transmit data or files located on user terminal 121 to user terminals 122 and 123. Alternatively or additionally, social network managing system 100 may receive data or files transmitted from user terminals 122 and 123. In some embodiments, user terminals 122 and 123 may access certain directories on user terminal 121, to either retrieve or drop off data/files.

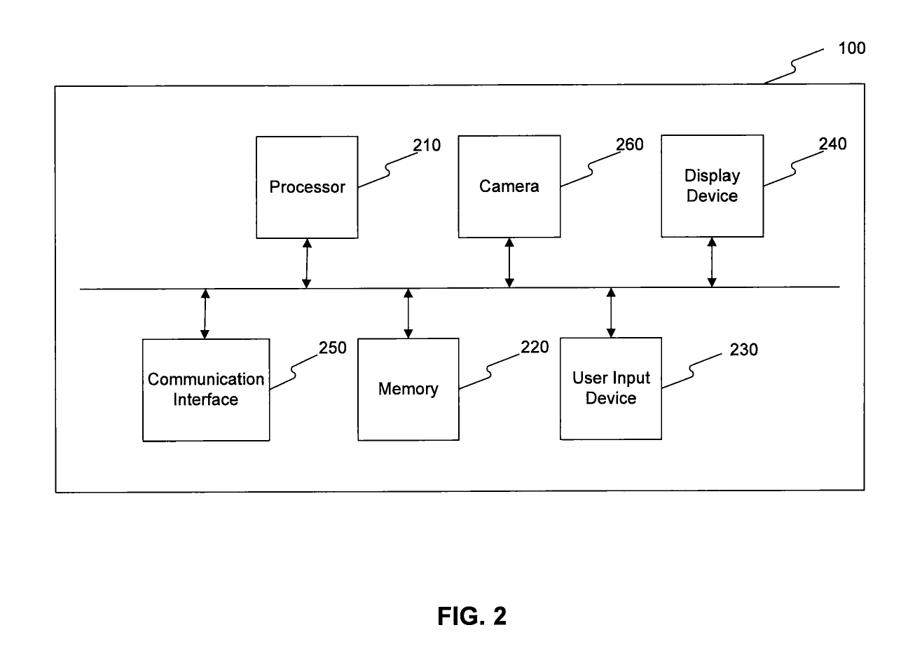

FIG. 2 illustrates a block diagram of an exemplary social network managing system 100, consistent with the disclosure. It is contemplated that social network managing system 100 may include more or fewer components than shown in FIG. 2. Consistent with some embodiments, user terminals 121-123 and social networking web servers 131-133 shown in FIG. 1, may also include components and configurations similar to those shown in FIG. 2.

As shown in FIG. 2, social network managing system 100 may include a processor 210, a memory module 220, a user input device 230, a display device 240, a communication interface 250, and a camera 260. Processor 210 can be a central processing unit (“CPU”) or a graphic processing unit (“GPU”). Depending on the type of hardware being used, processor 210 can include one or more printed circuit boards, and/or a microprocessor chip. Processor 210 can execute sequences of computer program instructions to perform various methods that will be explained in greater detail below.

Memory module 220 can include, among other things, a random access memory (“RAM”) and a read-only memory (“ROM”). The computer program instructions can be accessed and read from the ROM, or any other suitable memory location, and loaded into the RAM for execution by processor 210. For example, memory module 220 may store one or more software applications. Software applications stored in memory module 220 may comprise an operating system for common computer systems as well as for software-controlled devices. Further, memory module 220 may store an entire software application or only a part of a software application that is executable by processor 210. For example, memory module 220 may store social network managing applications that may be executed by processor 210.

In some embodiments, memory module 220 may also store master data, user data, application data and/or program code. For example, memory module 220 may store a content repository having thereon various tagged data, metadata, image files, video files, audio files, etc.

In some embodiments, user input device 230 and display device 240 may be coupled to processor 210 through appropriate interfacing circuitry. In some embodiments, user input device 230 may be a hardware keyboard, a keypad, or a touch screen, through which user 141 may input information to social network managing system 100. Display device 240 may include one or more display screens that display texts or graphs to user 141. For example, display device 240 may display a social networking map to user 141.

Communication interface 250 may provide communication connections such that social network managing system 100 may exchange information with external devices, such as user terminals 122 and 123, and social networking web servers 131-133. For example, communication interface 250 may include a WWAN or LAN adapter.

Camera 260 may be an integrated digital camera on social network managing system 100. In some embodiments, camera 260 may be built-in on top of display device 240. In some embodiments, camera 260 may be clipped or otherwise attached to display device 240, and connected to social network managing system 100 via a wired or wireless connection.

The components of system 100 are operatively connected, as shown in FIG. 2. Such connection may be wired or wireless. For example, certain components, such as processor 210 and memory module 220 may be connected by a data bus. Some other components, such as user input device 230 and display device 240, network interface 250, and camera 260, may be connected to other parts of system 100 via cables, or via wireless communication.

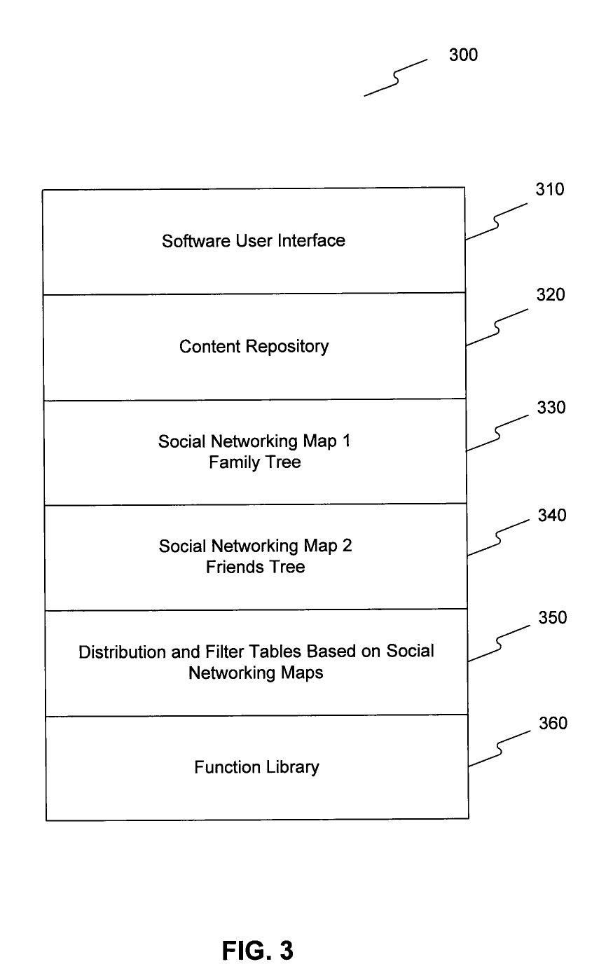

One or more components of system 100 may be used to execute software applications for social network management. For example, FIG. 3 illustrates a block diagram of an exemplary social network managing application 300. Consistent with some embodiments, social network managing application 300 may include a user interface 310, a content repository 320, a family tree 330, a friends tree 340, one or more distribution and filter tables 350, and a function library 360. It is contemplated that social network managing application 300 may include more or fewer components than shown in FIG. 3.

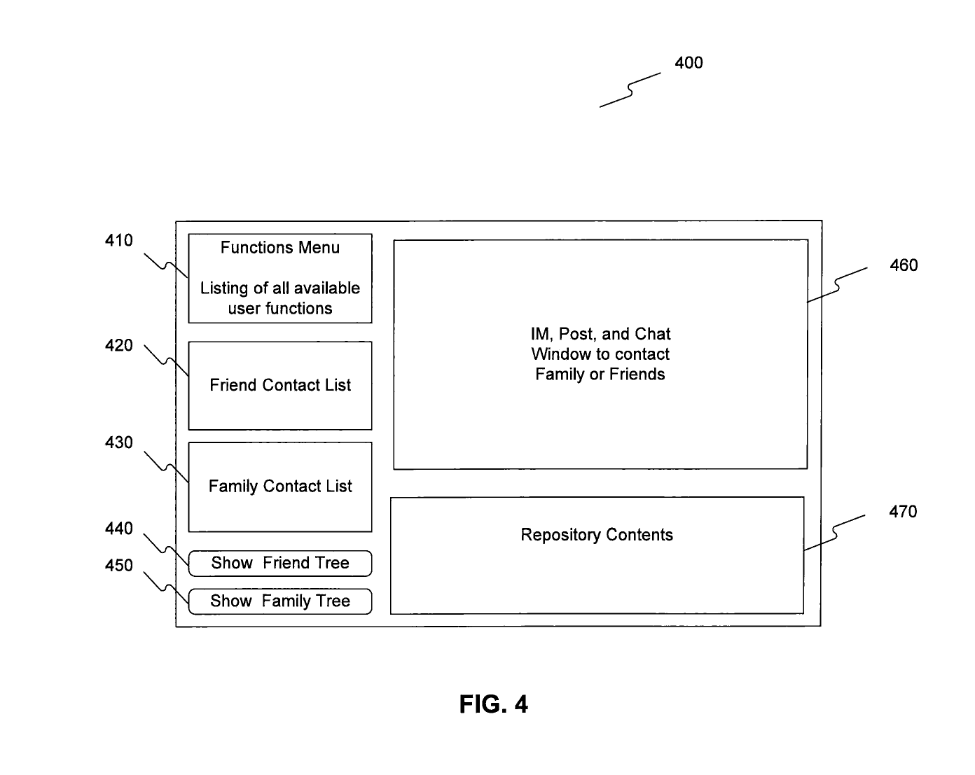

In some embodiments, user interface 310 may be displayed to user 141 on display device 240, once social network managing application 300 is launched. For example, FIG. 4 illustrates an exemplary user interface 400 for social network managing application 300, consistent with the disclosure. Consistent with some embodiments, user interface 400 may include one or more screen areas, including, for example, a functions menu 410, a friend contact list 420, a family contact list 430, a “show friend tree” button 440, a “show family tree” button 450, a message board or chatting interface 460, and a repository content display area 470. It is contemplated that user interface 400 may include more or fewer components than shown in FIG. 4.

In some embodiments, functions menu 410 may include a listing of available user functions offered by social network managing application 300. For example, the listing of user functions may correspond to function modules stored in function library 360. User 141 may click on a particular user function to launch the corresponding function module.

Friend contact list 420 may include a listing of friend contacts of user 141. The friend contacts may include user 141's real-life friends, as well as friends he makes online. Similarly, family contact list 430 may include a listing of family contacts of user 141. The list of friend contacts and the list of family contacts may be constructed using contact information downloaded from social network web servers 131-133.

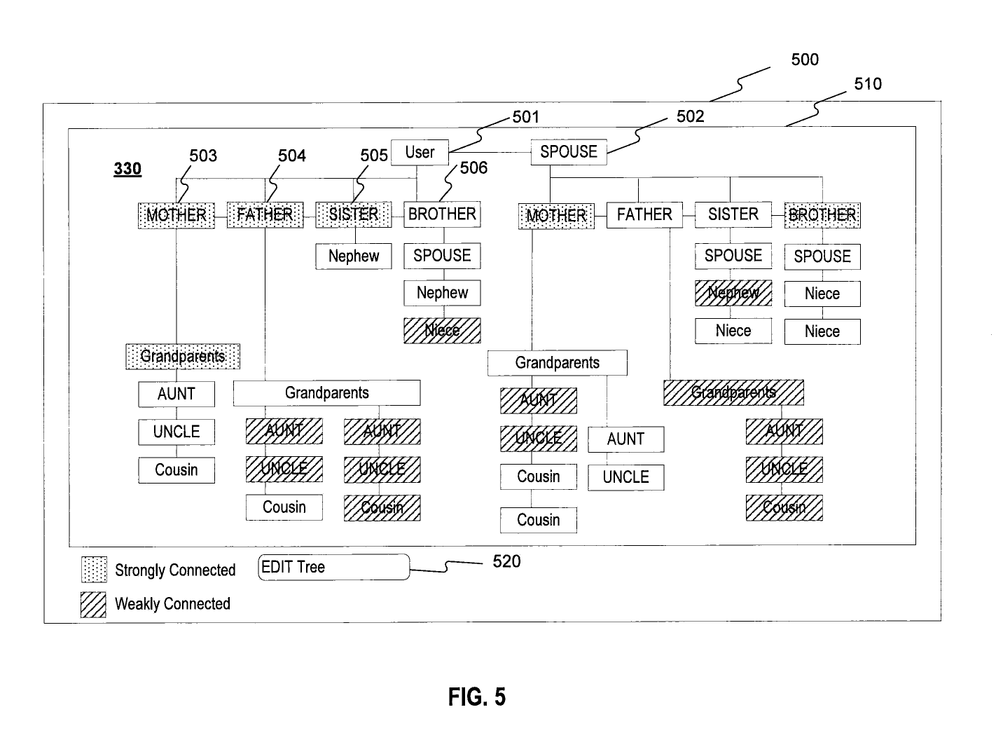

“Show friend tree” button 440 and “show family tree” button 450, once clicked, launch a separate user interface showing family tree 330 or friends tree 340 of the user. For example, FIG. 5 illustrates an exemplary family tree 330 shown on an user interface 500, consistent with the present invention. As shown in FIG. 5, user interface 500 may include a display region 510 that displays family tree 330. Family tree 340 may include a user icon 501, and a spouse icon 502 connected to user icon 501. User icon 501 and spouse icon 502 may be each connected to icons of their family members and relatives. For example, user icon 501 may be connected to a mother icon 503, a father icon 504, a sister icon 505, and a brother icon 506. Each of these icons may be further connected to the person's own family members. For example, father icon 504 may be connected to the father's parents, i.e., the user's grandparents, and the grandparents icons may be further connected to the grandparents' other children, e.g., the user's aunts and uncles.

In some embodiments, direct connections such as the connection between the user and his spouse, his parents, sisters, and brothers, may be considered as “primary connections.” Indirect connections such as the connections between the user and his grandparents, aunts, uncles, and cousins, may be considered as “secondary connections.” Secondary connections may be made through primary connections.

In some embodiments, the icons in family tree 330 may be highlighted in a manner to show the strength of connectivity between the user and the respective family contacts. In some embodiments, the icons may be highlighted in different colors, or different gray scales. For example, an icon may be highlighted with a darker color in family tree 330 if the strength of connectivity between the user and the respective contact. In some embodiments, the icons may also be highlighted with different marks, as shown in FIG. 5. The strength of connectivity may indicate how often the user communicates with the contact. In some embodiments, the strength of connectivity may be specified by the user through user interface 500. In some other embodiments, the strength of connectivity may be automatically determined by social network managing application 300.

As shown in FIG. 5, user interface 500 may further include an edit button 520 that allows the user to edit family tree 330 shown in display region 510. For example, once edit button 520 is clicked, the user may be allowed to edit the tree structures, add or delete contacts from family tree 330, edit names of the contacts, and add or change tags for the contacts. In some embodiments, the user may also be allowed to edit the strength of connectivity based on his perceptions.

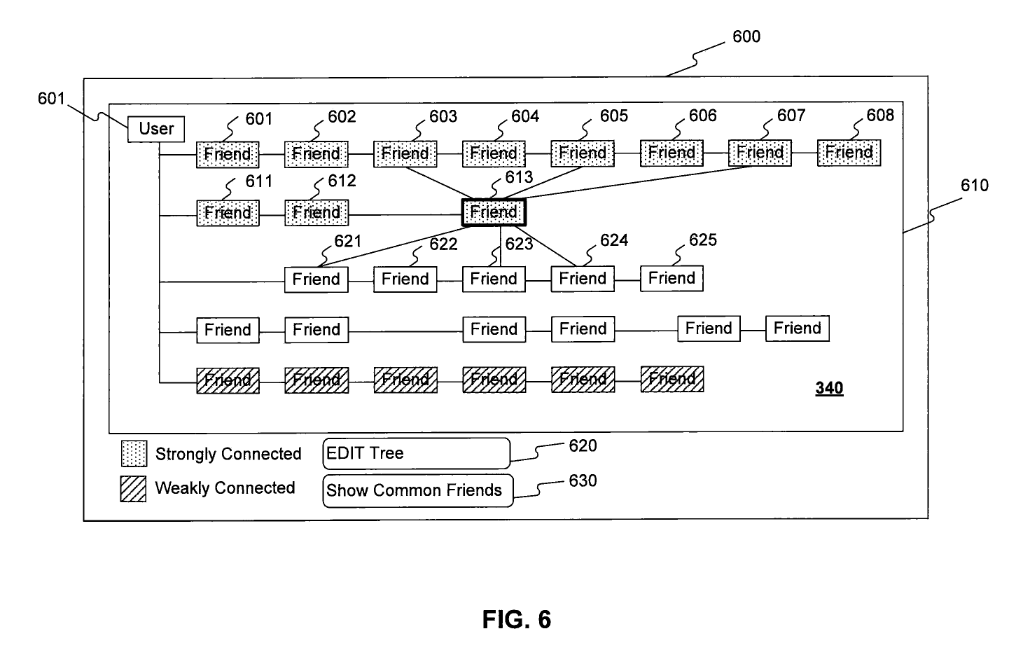

FIG. 6 illustrates an exemplary friends tree 340 shown on an user interface 600, consistent with the present invention. As shown in FIG. 6, similar to user interface 500, user interface 600 may include a display region 610 that displays friends tree 340 and an edit button 620 that allows the user to edit friends tree 340.

Friends tree 340 may include a user icon 601, and icons of one or more friends groups of the user. For example, the user may have several different friends chains: colleagues, classmates, church members, players in his soccer team, people he knows at his country club, parents of his daughter's classmates, etc. In some embodiments, icons of contacts in the same friends chains are displayed on a same level. For example, as shown FIG. 6, friend icons 601-608 that correspond to the user's friends at work are displayed on one level, while friend icons 611-613 that correspond to the user's college friends are displayed on another level, and friend icons 621-625 that correspond to the user's golfing friends are displayed in yet another level.

In some embodiments, the icons in friends tree 340 may also be highlighted in a manner, similar as described above in connection with FIG. 5, to show the strength of connectivity between the user and the respective friend contacts. The user may use edit button 620 to edit friends tree 340 shown in display region 610. For example, once edit button 620 is clicked, the user may be allowed to add or delete friends, rearrange the tree structures, edit names of the friends, and add or change tags for the friends. In some embodiments, the user may also be allowed to edit the strength of connectivity.

Contacts of different friends chains may be sometimes also friends of each other. For example, John (corresponding to friend icon 613), the user's college classmate, is also a friend of James, Jenny, and Jane (corresponding to friend icons 603, 605, and 607), the user's colleagues at work, as well as Jason, Jack, and Jim (corresponding to friend icons 621, 623, and 624), the user's golf partners. In some embodiments, user interface 600 may further include a common friend button 630 that allows the user to find out the common friends of a selected friend in friends tree 340. For example, the user may highlight friend icon 613 in friends tree 340 and then click common friend button 630. Accordingly, the connections between friend icon 613 and friend icons 603, 605, 607, 621, 623, and 624 may be shown or highlighted in display region 610.

Referring back to FIG. 4, a message board or chatting interface 460 may be provided for the user to chat with one or more of his family members or friends. In some embodiments, message board or chatting interface 460 may include more than one chatting interfaces so that the user can simultaneously chat with multiple contacts. The chatting interfaces may be switched by tabs. If a contact is not online, the user may leave him/her a message on message board or chatting interface 460.

Content repository 320 may store networking content such as tagged data, metadata, image files, video files, audio files. Repository content display area 470 may be configured to display the networking content stored on content repository 320. For example, when the user is chatting with a contact, a list of networking content associated with that contact may be displayed in repository content display area 470. In some embodiment, each of the content may be displayed in a summary form, for example, including the content name, retrieved time, and the social networking web server from which it was retrieved. In some embodiments, repository content display area 470 may also be configured to display the content in detail. For example, the image or the video may be displayed.

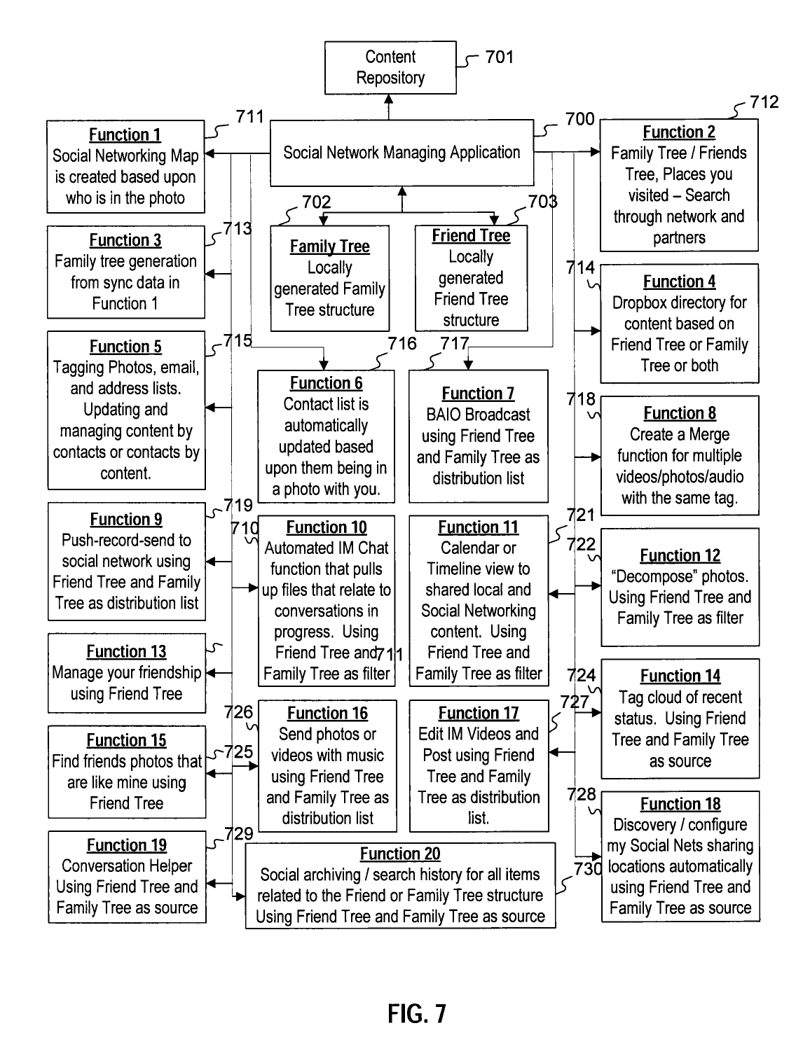

FIG. 7 illustrates function modules of exemplary social network managing application 700, consistent with the disclosure. Consistent with some embodiments, social network managing application 700 may include a content repository module 701, a family tree module 702, a friends tree module 703, and function functions 711-730. It is contemplated that social network managing application 700 may include more or fewer modules than shown in FIG. 7.

Content repository module 701 may store networking content such as tagged data, metadata, image files, video files, audio files. In some embodiments, content repository module 701 may be updated automatically by social network managing application 700 or upon user request. For example, every time social network managing application 700 is launched, it may automatically log into social networking web servers to check if any new networking content are available for download. In some embodiments, content repository module 701 may be stored locally on social network managing system 100. In some embodiments, content repository module 701 may also be stored on a remote server Internet 110.

Family tree module 702 may store data for displaying the family tree, such as on user interface 500. For example, family tree module 702 may store names of the family contacts, their relationships with the user, the strength of connectivity of each contact, etc. Similarly, friends tree module 703 may store data for displaying the friends tree, such as on user interface 600. For example, friends tree module 703 may store names of the friends, their relationships with the user and their relationships with other friends in the tree, the strength of connectivity of each friend, etc.

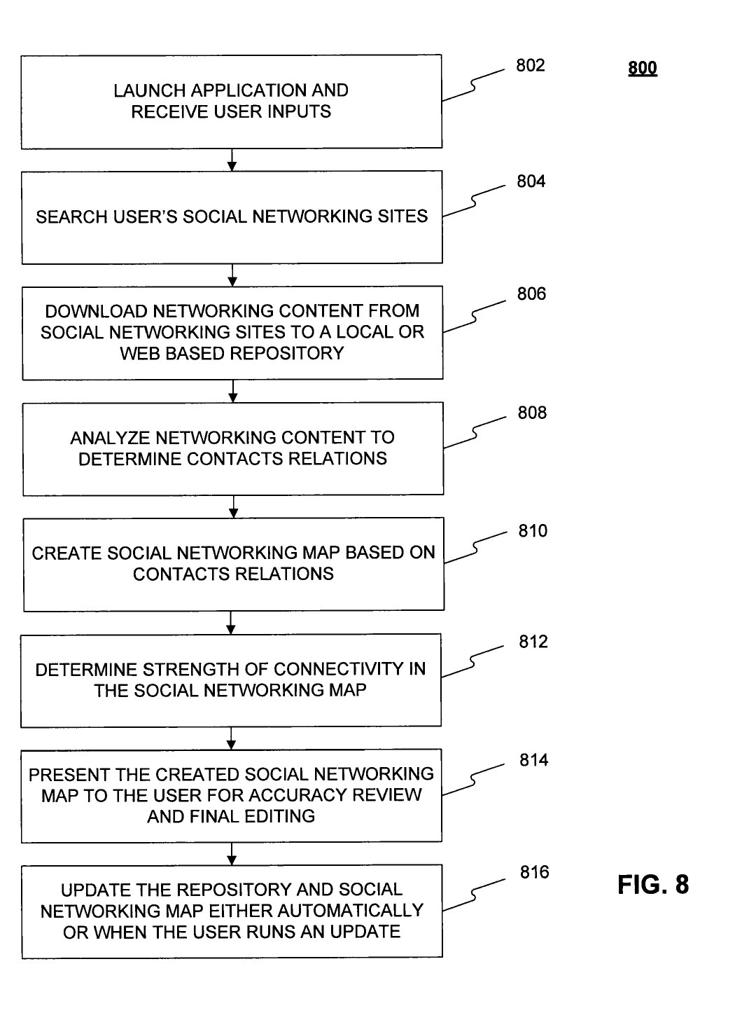

Function modules 711-730, when executed by processor 210, may each perform a function process for creating, updating, or otherwise utilizing a social networking map, such as the family tree or the friends tree. Each function module is described in greater details in connection with FIGS. 8-32.

Each of modules 701-703 and 711-730 may transmit data to or receive data from other modules. For example, each of function modules 711-730 may access content depository 701 and data/files stored thereon. In some embodiments, one or more function modules 711-730 may be executed simultaneously, or sequentially.

FIG. 8 is an exemplary flow chart for creating a social networking map, performed by function module 711 in FIG. 7. Process 800 may start when the user launches social network managing application 700 (step 802), e.g., on his personal computer, PDA, or mobile phone. In step 802, the user may input certain information, such as through user input device 230. In some embodiments, the user may be asked to input identity information, e.g., the name, email, phone number, address, or online ID, of at least two friend and family contacts. For example, the user may input the email addresses of his father and sister. In some embodiments, the user may be further asked to input his own social networking site logins. For instances, the user may input his login information for his Facebook™ account and LinkedIn™ account.

With the user input information, social network managing application 700 may search the user's social networking sites (step 804). For example, social network managing application 700 may log into the user's Facebook™ account and LinkedIn™ account to search for data related to the input contacts. The data may include additional family contacts of the user (either connected to the user directly or connected to the input contacts of the user), relationships between the user and these contacts, as well as networking content related to these contacts on the user's social networking sites.

In step 806, the networking content found on the social networking sites during step 804 may be downloaded and stored on a local or web based repository, such as content repository module 701. The networking content may include photos and videos of the contacts, chatting histories, account profiles, posts, etc. The networking content may be analyzed in step 808 for determining the relations between the user and the contacts. In some embodiments, the networking content may be further sorted into categories based on the analysis.

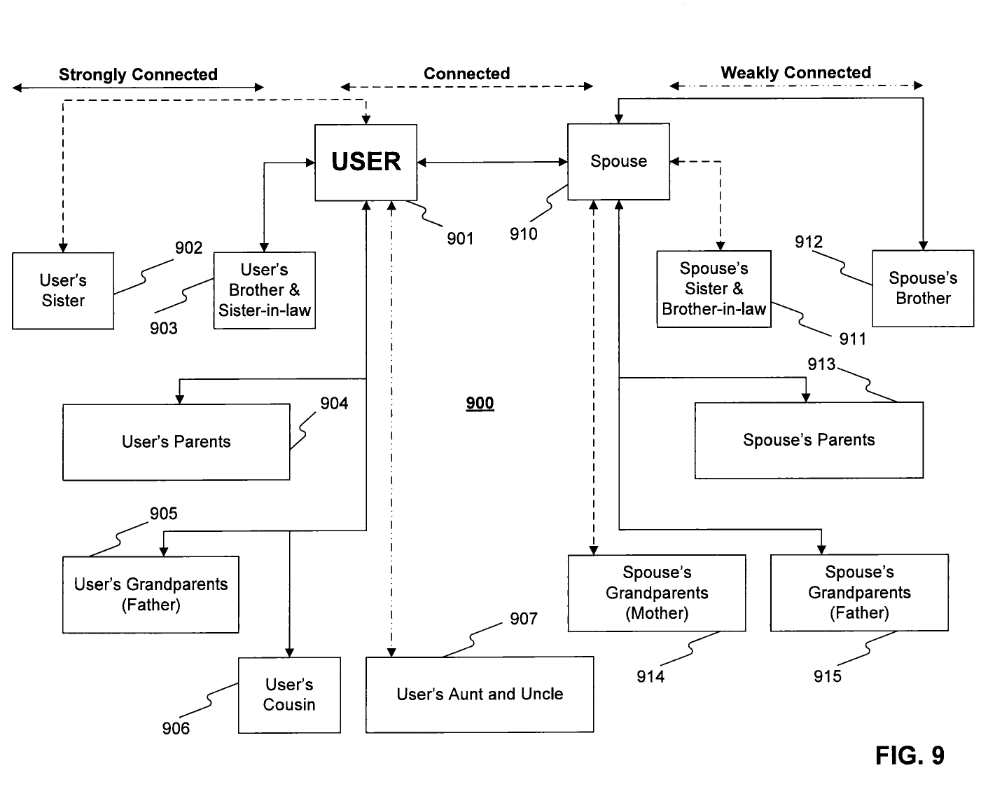

In step 810, a social networking map, e.g., a family tree or a friends tree, may be created based on the user's relations with the contacts. FIG. 9 illustrates an exemplary family tree 900, consistent with the present invention. Based on the family relationship, user 901 may be connected to his spouse his sister 902, his brother and sister-in-law 903, his parents 904, his grandparents (father side) 905, his cousin 906, and his aunt and uncle 907. User 901 may also be connected to his spouse 910, who is further connected to her sister and brother in law, her brother, her parents, her grandparents (mother side) 911 and her grandparents (father side) 912. In some embodiments, the networking content may be associated with each contact in the social networking map.

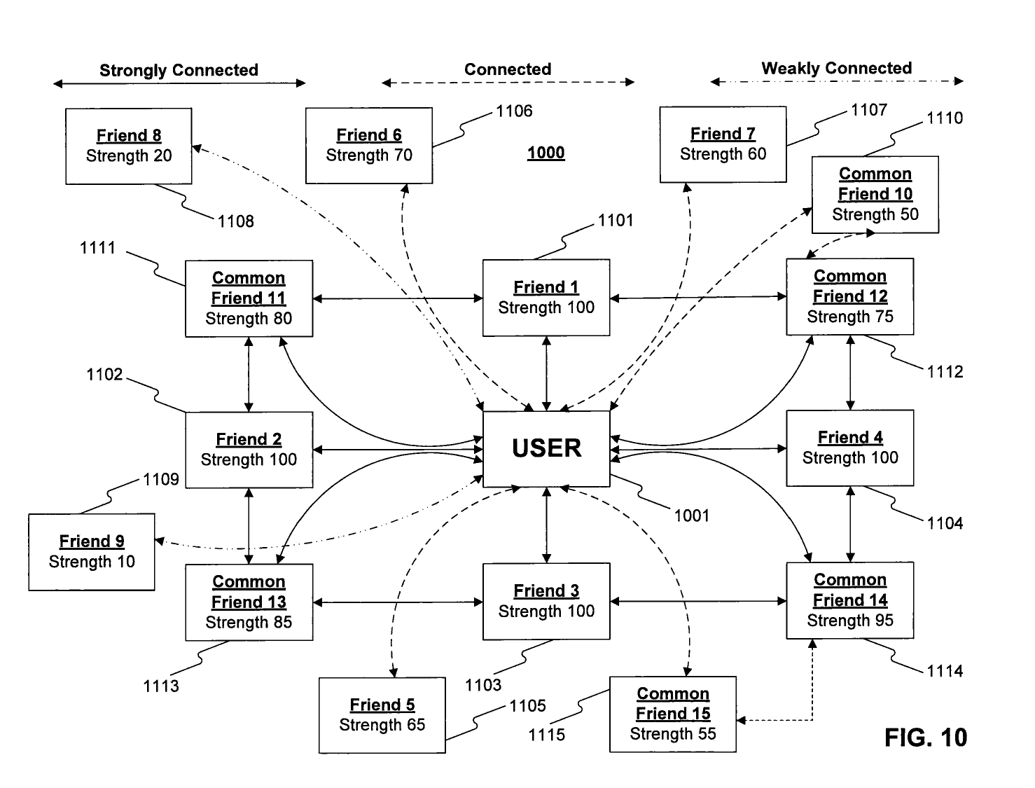

FIG. 10 illustrates an exemplary friends tree 1000, consistent with the present invention. For example, user 1001 may be connected to friends 1101-1115 in friends tree 1000. In some embodiments, among the friends connected to the user, some may be friends to each other. These friends may be marked as common friends in friends tree 900, such as common friends 1110-1115.

In some embodiments, strength of connectivity of each connection may be determined and included in the social networking map (step 812). The strength of connectivity may be determined based on common connections to the networking content between the user and respective contacts. In some embodiments, the strength of connectivity may be determined based on the frequency of communication between the user and a contact or between two contacts. For example, if the user chats every day with his sister but only once a month with his brother, it may be determined that the connectivity between he and his sister is stronger than the one between he and his brother.

In some embodiments, the strength of connectivity may be indicated by using different lines to mark the connections in the social networking map. For example, as shown in FIG. 9, solid lines are used for strong connections, dashed lines are used for normal connections, and dotted-dashed lines are used for weak connections. In some embodiments, the strength of connectivity may be further determined as a number and assigned to each contact in the social networking map. For example, as shown in FIG. 10, friend 1101 is assigned a strength of 100, indicating that he is strongly connected with the user, while friend 1109 is assigned a strength of only 10, indicating that he is only weakly connected with the user.

The created social networking map may be presented to the user for accuracy review and/or final editing (step 814). For example, a family tree may be displayed to the user by user interface 500, as shown in FIG. 5, or a friends tree may be displayed by user interface 600, as shown in FIG. 6. The user may click edit button 520 or edit button 620 to edit the trees.

The social networking map may be updated (step 816). In some embodiments, an update may be automatically made upon the next launch of social network managing application 700. In some embodiments, an update may be initiated by the user.

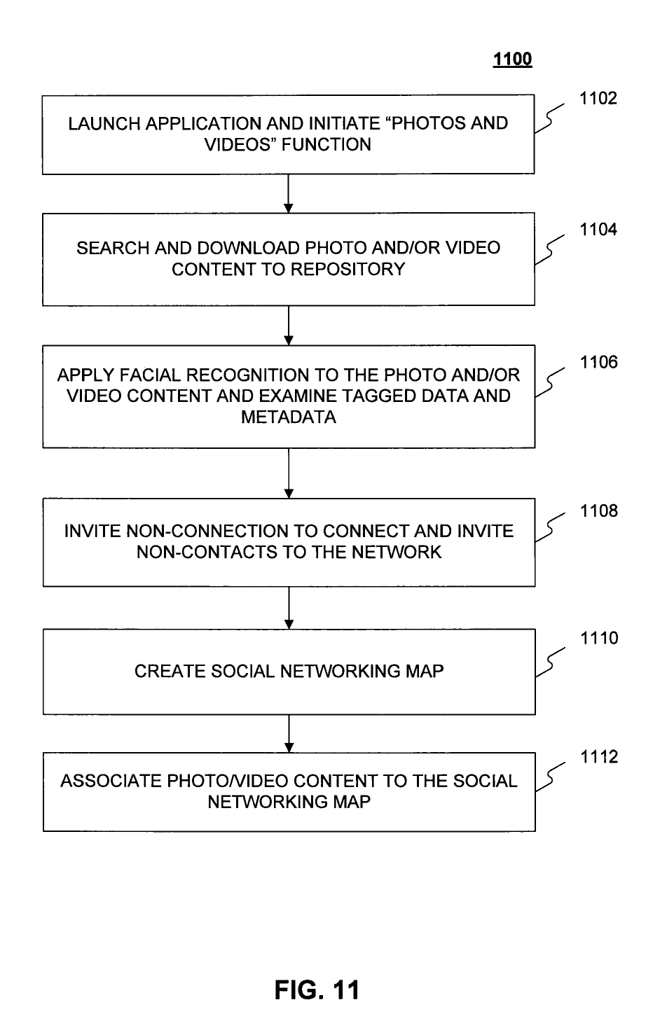

FIG. 11 is an exemplary flow chart for generating a social networking map based on photos, consistent with the present invention. Process 1100 may start when the user launches social network managing application 700 and initiates the “photos and videos” function (step 1102). Upon the launch, social network managing system 100 may log onto the user's social networking sites and search for photo and/or video content (step 1104). The obtained photo and/or video content may be downloaded to a local or web based repository.

In step 1106, facial recognitions or other image processing techniques may be applied to the photos/videos to determining the identities of people in the photos/videos. For example, a photo may be taken at an alumni event held at the user's college, and the photo may include the user and his classmates. Social network managing system 100 may apply facial recognition on the photo and determine that the user, and his classmates Jason, Jim, and Jack are in the photo. In some embodiments, the tagged data and metadata in the networking content may be examined, such as the description data of the photo. For example, the description of the photo may indicate who are in the photo.

It may be further determined if the people in the photo are connected to the user in the network. If a person in a photo/video with the user is not connected to the user on the network, he may be invited to connect (step 1108). Additionally in step 1108, if a person in a photo/video is not available on the network, he may be invited to join the network.

In step 1110, a social networking map, e.g., a family tree or a friends tree, may be created based on the user's relations to those contacts in the photos/videos. In some embodiments, the photos/videos may be further sorted by contacts and assorted with each contact in the social networking map (step 1112). For example, a photo of the user and his parents may be associated which the parents contact in the family tree.

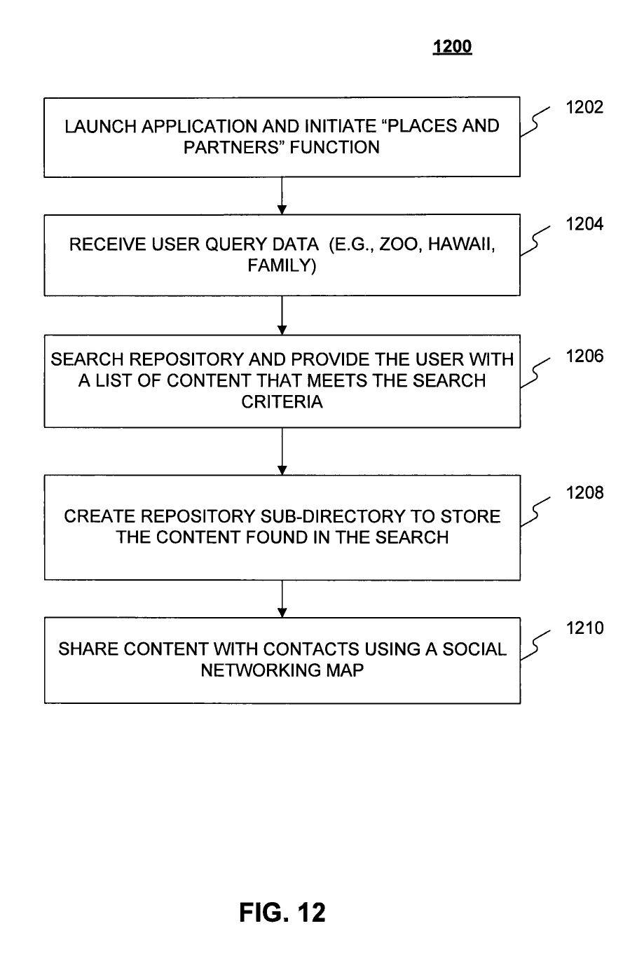

FIG. 12 is an exemplary flow chart for searching networking content according to a user query, consistent with the present invention. Process 1200 may start when the user launches social network managing application 700 and initiates the “places and partners” function (step 1202). The user may input a search query via user input interface 230 (step 1204). For example, the user may input places of visits, such as “zoo”, “Hawaii”, or any other query keywords, such as “family”, “thanksgiving,” “birthday,” etc.

In step 1206, social network managing system 100 may search the content repository for networking content related to the user query. In some embodiments, the search may apply facial recognitions on image/video content, as well as examining the tagged data and metadata in the repository, for matches. A list of content obtained during the search may be provided to the user.

In some embodiments, a repository sub-directory may be created locally on social network managing system 100 or remotely on Internet 110, to store the search results that match the user query (step 1208). The content may be shared with the user's contacts (step 1210). In some embodiments, the user may select contacts, using the social networking map, to share the content with. Social network managing system 100 may communicate with user terminals of the selected contacts to share the content. In some embodiments, the content may be sent to the contacts, e.g., via e-mails. In some embodiments, the contacts may be provided with access information to access the repository sub-directory created in step 1208.

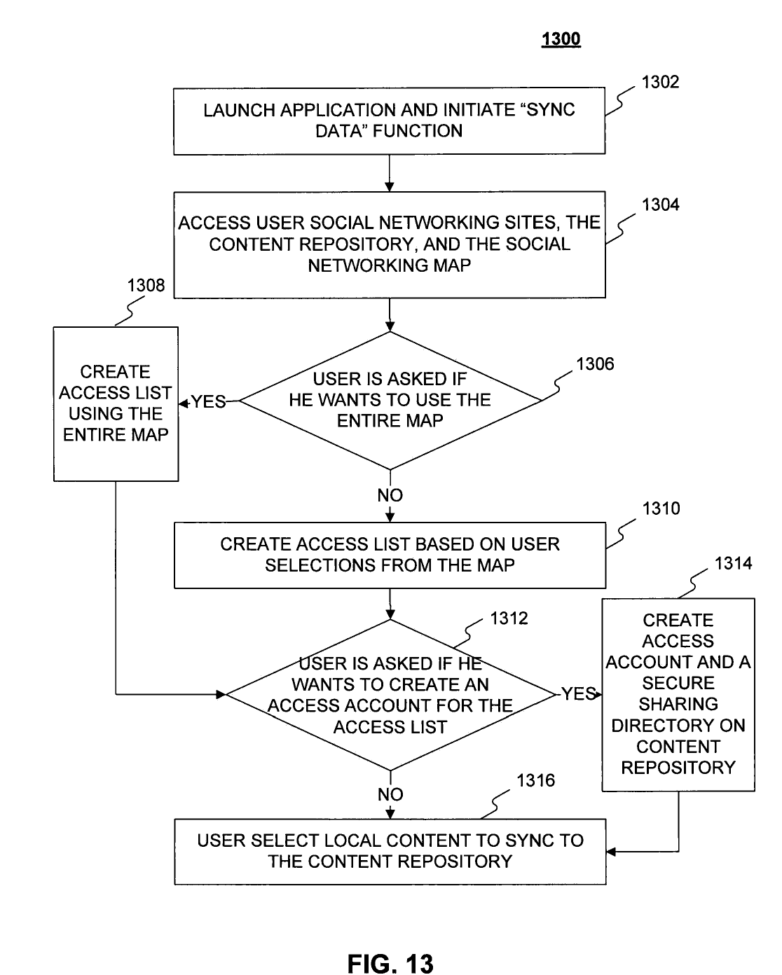

FIG. 13 is an exemplary flow chart for sharing networking content on a repository, consistent with the present invention. Process 1300 may start when the user launches social network managing application 700 and initiates the “sync data” function (step 1302). Social network managing application 700 may access the user's social networking sites using his login information, as well as content repository module 701 and the social networking map, e.g., family tree module 702 and friends tree module 703 (step 1304).

Social network managing application 700 may check with the user if he wants to use the entire social networking map for creating the access list (step 1306). For example, once the “sync data” function is initiated, a dialog window may be provided to the user for his decision. If the user chooses to use the entire map (step 1306: yes), an access list may be created to include the contacts in the social networking map (step 1308). An access list may include the names of the contacts and their contact information, such as email addresses, network site pages, mailing addresses, etc. If the user does not want to use the entire map (step 1306: no), the user may be prompted to select contacts from the social networking map to be included in the access list (step 1310). For example, the user may highlight the selected contacts in the family tree on user interface 500 or the friends tree on user interface 600. In step 1310, an access list may be created based on the user selection.

In step 1312, social network managing application 700 may check with the user if he wants to create an individual access account for contacts on the access list to log in and share networking content on the content repository. For example, a dialog window may be provided to the user for his decision. If the user chooses to create an access account (step 1312: yes), the access account and associated access information may be created (step 1314). In step 1314, a secure sharing directory that the contacts on the access list can access may be created on the content repository. For example, once the contacts input the access information, they may be placed in the sharing directory. In some embodiments, access to the secure sharing directory may be limited only to the user and those contacts on the access list.

If the user chooses not to create an access account (step 1312: no), step 1314 may be skipped. In step 1316, the user may be allowed to select networking content available locally on the user terminal to sync to the content repository. In particular, if the secure sharing directory is created, the selected content may be shared to this directory.

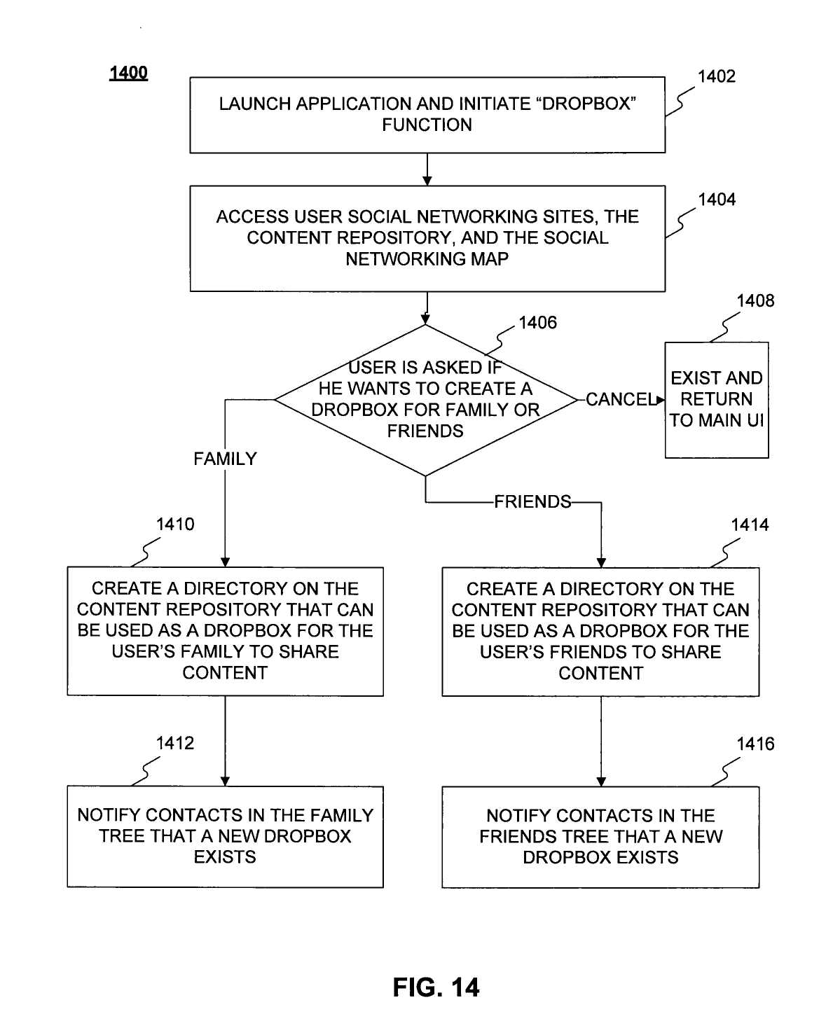

FIG. 14 is an exemplary flow chart for generating a Dropbox directory on a repository, consistent with the present invention. Process 1400 may start when the user launches social network managing application 700 and initiates the “Dropbox” function (step 1402). Social network managing application 700 may access the user's social networking sites using his login information, as well as content repository module 701 and the social networking map, e.g., family tree module 702 and friends tree module 703 (step 1404).

Social network managing application 700 may check with the user if he wants to create a Dropbox on the repository for his family or friends (step 1406). For example, once the “Dropbox” function is initiated, a dialog window may be provided to the user for his decision. If the user chooses not to create a Dropbox (step 1406: canceled), process 1400 may terminate and return to the main user interface (step 1408).

If the user chooses to create a Dropbox for his family contacts on the social networking map (step 1406: family), a directory may be created on the repository as a Dropbox for the family contacts (step 1410) and the family contacts may be notified that a Dropbox exists for access (step 1412). Similar, if the user chooses to create a Dropbox for his friends on the social networking map (step 1406: friends), a directory may be created on the repository as a Dropbox for the friends (step 1414) and the friends may be notified that a Dropbox exists for access (step 1416). In some embodiments, the notification provided in either step 1414 or step 1416 may include access information to the Dropbox.

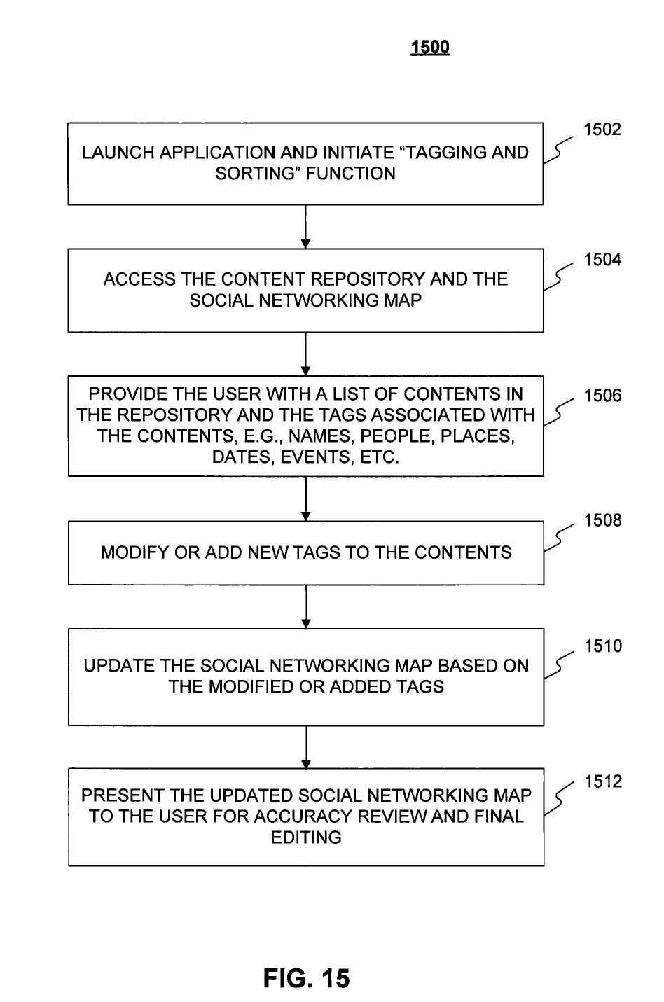

FIG. 15 is an exemplary flow chart for tagging content and updating a social networking map, consistent with the present invention. Process 1500 may start when the user launches social network managing application 700 and initiates the “tagging and sorting” function (step 1502). Social network managing application 700 may access content repository module 701 and the social networking map, e.g., family tree module 702 and friends tree module 703 (step 1504).

In step 1506, the user may be provided with a list of networking content stored in the repository and tags that may be associated with the content. The tags may be used to indicate different categories of content. Examples of tags may include names such as last name “Smith”, people such as “doctors” or “students”, places such as “zoo” or “Hawaii”, dates such as “May 1, 2010” or “Thanksgiving day,” and events such as “wedding”, “party”, or “charity”. It is contemplated that a content may bear one or more tags. For example a video shot at a wedding in Hawaii may be tagged with “Hawaii” as well as “wedding.”

In step 1508, the user may be allowed to add tags to the networking content, or edit existing tags on the networking content. For example, the user may modify the tags to content shown in repository content area 470. Based on the modified tags, the social networking map may be updated accordingly (step 1510). The updated social networking map may be presented to the user for accuracy review and/or final editing (step 1512). For example, a family tree may be displayed to the user by user interface 500, as shown in FIG. 5, or a friends tree may be displayed by user interface 600, as shown in FIG. 6. The user may click edit button 520 or edit button 620 to edit the trees.

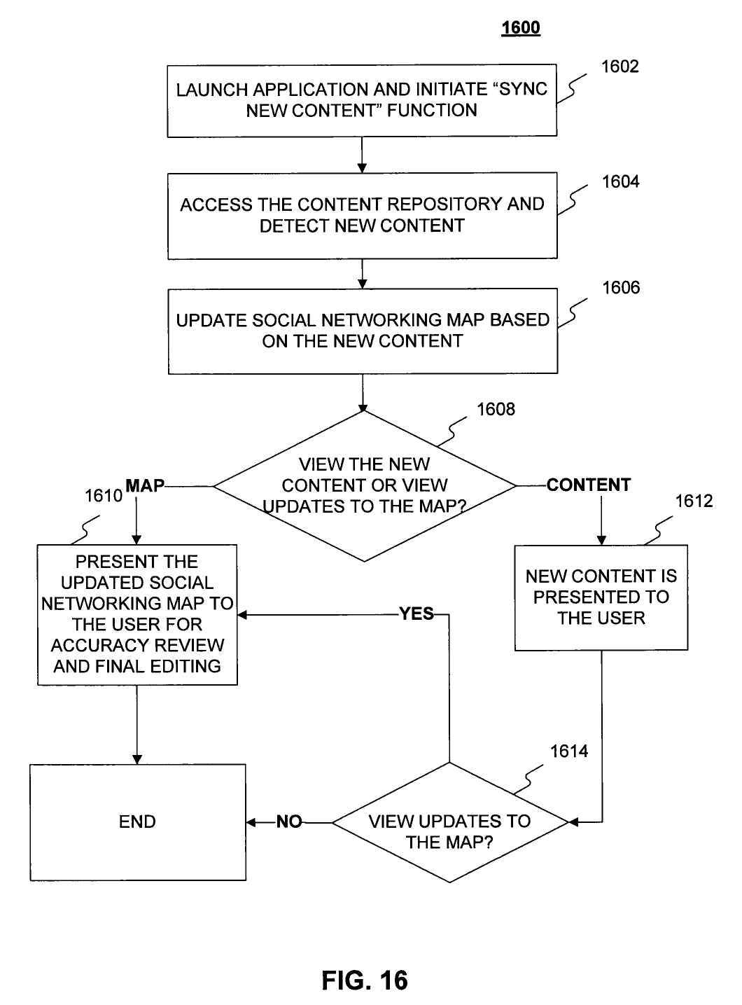

FIG. 16 is an exemplary flow chart for tagging content and updating a social networking map, consistent with the present invention. Process 1600 may start when the user launches social network managing application 700 and initiates the “sync new content” function (step 1602). Social network managing application 700 may access content repository module 701 and check if any new networking content is available (step 1604).

If new content is detected from the repository, the new content may be analyzed as described in step 808 in connection with FIG. 8. For example, facial recognition may be applied to the new content, and the tagged data and metadata in the new content may be examined. In step 1606, the social networking map may be updated based on an analysis of the new content. For example, facial recognition may be applied to the new content.

In step 1608, social network managing application 700 may check with the user if he wants to view the new networking content or view the updated social networking map. For example, a dialog window may be provided to the user for his decision. If the user chooses to view the map (step 1608: map), the updated social networking map may be presented to the user for accuracy review and/or final editing (step 1610). For example, the family tree may be displayed in display region 510 on user interface 500 and the friends tree may be displayed in display region 620 on user interface 600. If the user chooses to view the new content (step 1608: content), the new content may be displayed to the user (step 1612) in content repository area 470.

After the user views the new content, social network managing application 700 may further check with the user if he wants to view the updated social networking map (step 1614). If the user declines to view the updates (step 1614: no), process 1600 may terminate. Otherwise (step 1614: yes), process 1600 may go to step 1610 to present the updates to the user.

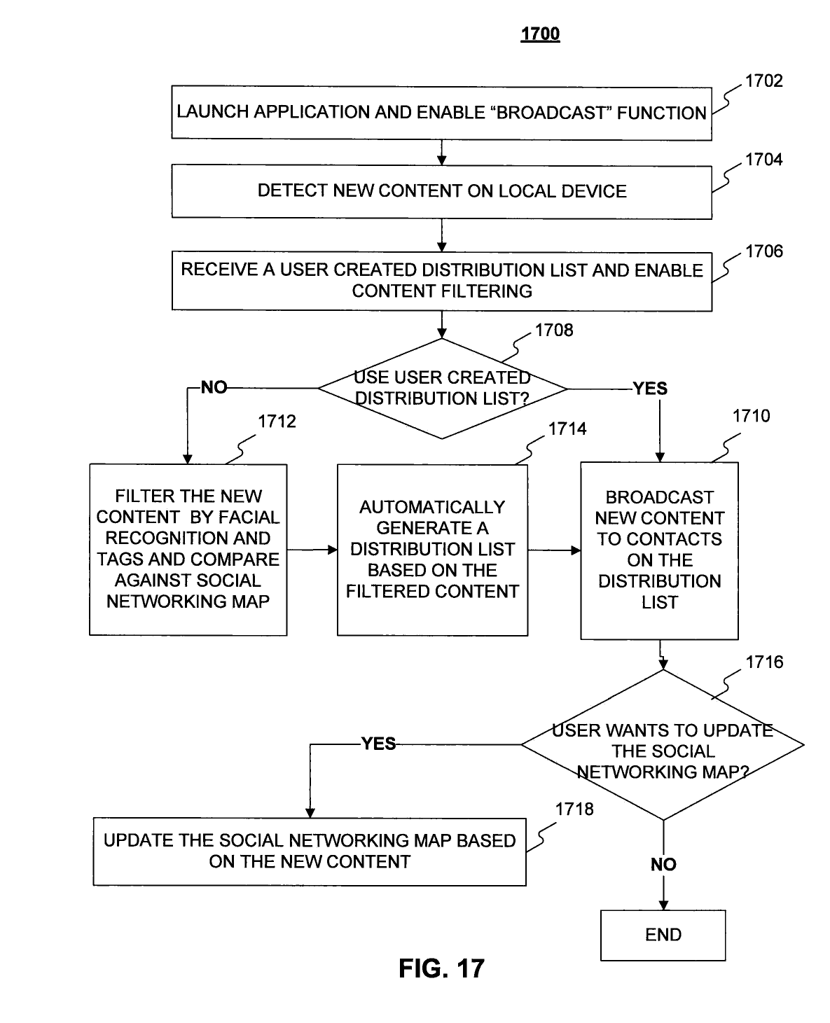

FIG. 17 is an exemplary flow chart for distributing content to contacts in a social networking map, consistent with the present invention. Process 1700 may start when the user launches social network managing application 700 and enable the “broadcast” function (step 1602). In some embodiments, the “broadcast” function may be implemented with Sony VAIO™ broadcast feature. The broadcast function may detect new content on local device (step 1604), such as a Sony VAIO™ laptop. For example, the new content may be recently generated on the local device or recently downloaded to the local device. In some embodiments, the new content may be an image, a video, or an audio file.

The user may be allowed to create a distribution list (step 1706). For example, the user may select one or more contacts on the social networking map to create the distribution list. The distribution list may include the names of the contacts and their contact information, such as email addresses, network site pages, mailing addresses, etc. In step 1706, content filtering may be enabled. In step 1708, social network managing application 700 may check with the user if he wants to use the distribution list to broadcast the new content. If the user agrees to use the distribution list created by his own (step 1708: yes), the new content may be broadcasted to all the contacts on the distribution list (step 1710).

If the user does not want to use the distribution list created by his own (step 1708: no), a distribution list may be automatically created to include the contacts that are related to the new content. In step 1712, the new content may be filtered. In some embodiments, the new content may be filtered by, e.g., facial recognition results and/or tagged data. In some embodiments, the facial recognition results and tags may be compared against the social networking map to determine who should be included in the distribution list. For example, facial recognition may be applied to a soccer team group photo recently downloaded to the user's local laptop. The people in the photo may be identified by comparing the facial recognition results against the social networking map. In step 1714, a distribution list may be automatically created to include the contacts that are related to the new content.

In addition or alternative to steps 1710-1714, the distribution list may also be automatically created based on the strength of connectivity indicated by the social networking map. In some embodiments, the distribution list may include contacts that have a strength of connectivity higher than a predetermined threshold. For example, the distribution list may include contacts whose strengths are higher than 85 in FIG. 10, which may include friends 1101-1104, 1113, and 1114.

The new content may then be broadcasted according to the automatically created distribution list (step 1710). The user may be further asked to decide if he wants to update the social networking map based on the new content (step 1716). If the user declines (step 1716: no), process 1700 may terminate. Otherwise (step 1716: yes), the social networking map may be updated on an analysis of the new content (step 1718). For example, facial recognition may be applied to the new content.

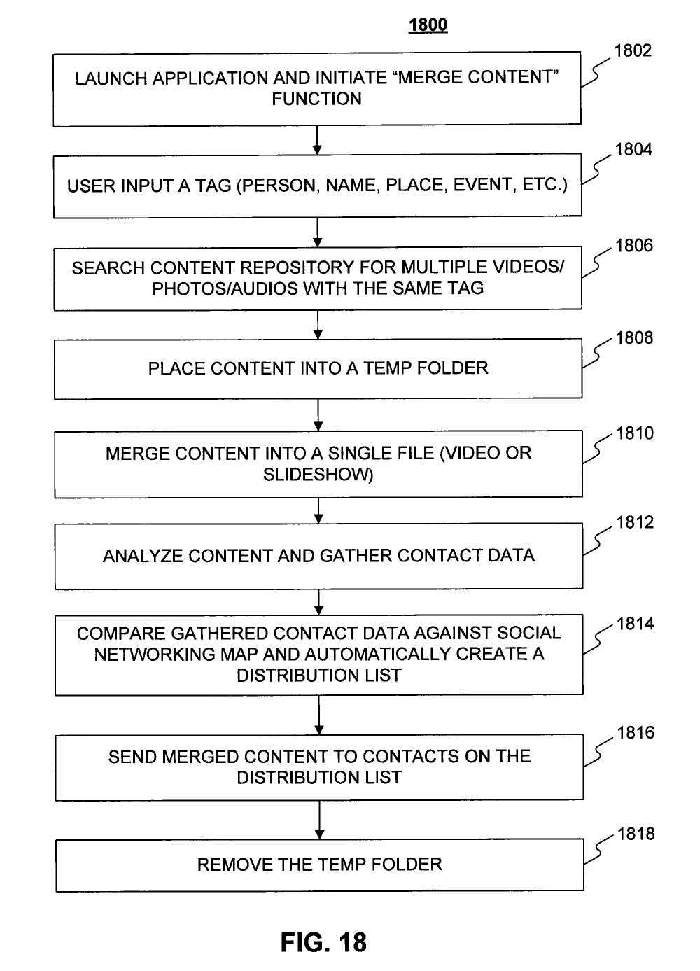

FIG. 18 is an exemplary flow chart for merging content with a same tag, consistent with the present invention. Process 1800 may start when the user launches social network managing application 700 and initiates the “merge content” function (step 1702). The user may input a tag from user input device 230 (step 1804). Consistent with some embodiments, the user may input a person, a name, a place, an event, etc. The content repository may be searched for content that is associated with the user input tag (step 1806). For example, if the user inputs a tag “wedding,” all content on the content repository associated with “wedding” may be located during the search. In some embodiments, the user may input more than one tags, such as “Jamey's wedding.” Accordingly, content associated with both “Jamey” and “wedding” may be located during the search. In some embodiments, multiple files such as multiple photos/videos/audios may be located.

In step 1808, the search located content may be placed in a temp folder on the content repository. The content may be merged into one single file (step 1810). For example, multiple videos related to Jamey's wedding may be merged into one video file. As another example, multiple photos related to Jamey's wedding may be merged into a photo slideshow, or a master image file like a college print.

In step 1810, the content in the temp folder may be analyzed to gather contact data. In some embodiments, facial recognition may be applied and/or the tagged data and metadata may be examined to extract information of the people involved in the content. For example, the search located photos related to Jamey's wedding may be analyzed to extract features related to the people in the photos.

In step 1812, the contact data may be compared against the social networking map to determine the identifications of the people involved in the content. For example, the facial recognition results of the photos and tags may be compared against the social networking map to determine who are in the photos. Based on the determination, a distribution list including the people involved in the content may be created. For example, if a hundred guests are identified in the photos related to Jamey's wedding, the distribution list may be created to include those a hundred guests.

The merged content may be sent to the contacts on the distribution list (step 1814). For example, a merged video file may be sent to everyone who appears in the video. After the merged content is sent, the temp folder may be removed (step 1816).

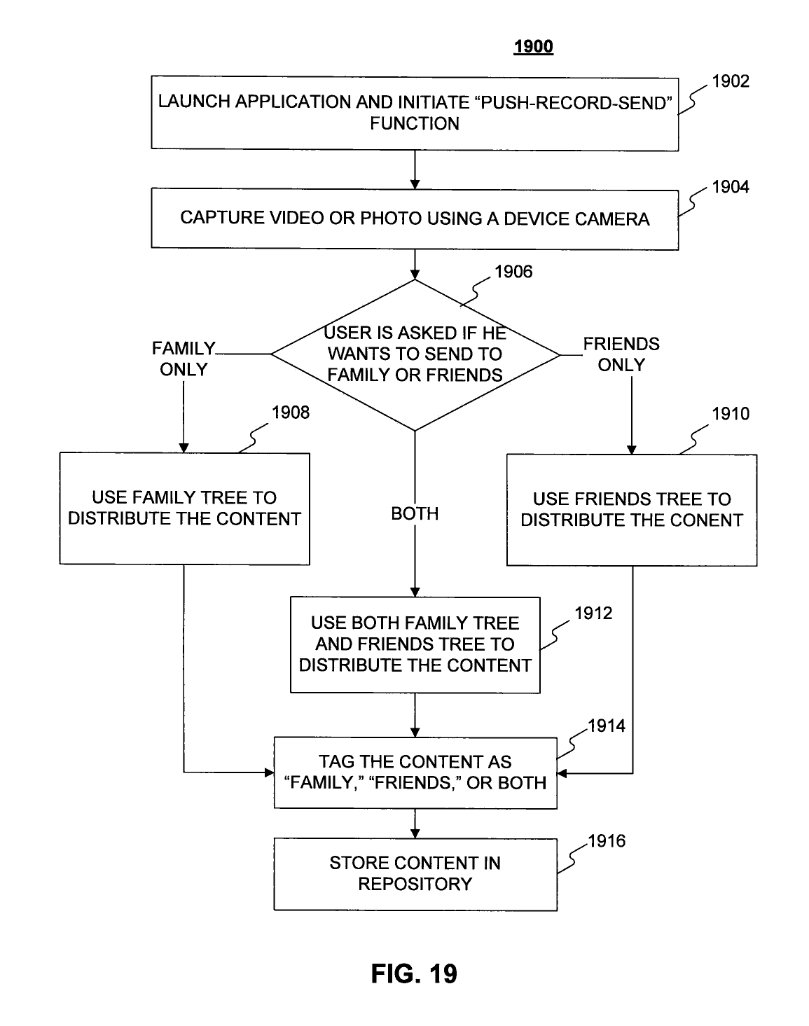

FIG. 19 is an exemplary flow chart for recording content and sending the content to users in a social networking map, consistent with the present invention. Process 1900 may start when the user launches social network managing application 700 and initiates the “push-record-send” function (step 1802). In step 1804, a video or a photo may be captured by camera 260 build-in on social network managing system 100. For example, a photo may be captured during an online chatting event.

In step 1906, social network managing application 700 may check with the user if he wants to share the captured content with his family or friends. If the user chooses to share the content with family only (step 1906: family only), the content may be sent to all the contacts in his family tree (step 1908). If the user chooses to share the content with friends only (step 1906: friends only), the content may be sent to all the contacts in his friends tree (step 1910). Alternatively, if the user chooses to share the content with both family and friends (step 1906: both), the content may be sent to all the contacts in his friends tree as well as his family tree (step 1912).

In step 1914, the content may be tagged “family,” “friends,” or both depending on the choice of the user in step 1906. The tagged content may be then placed on the content repository (step 1916).

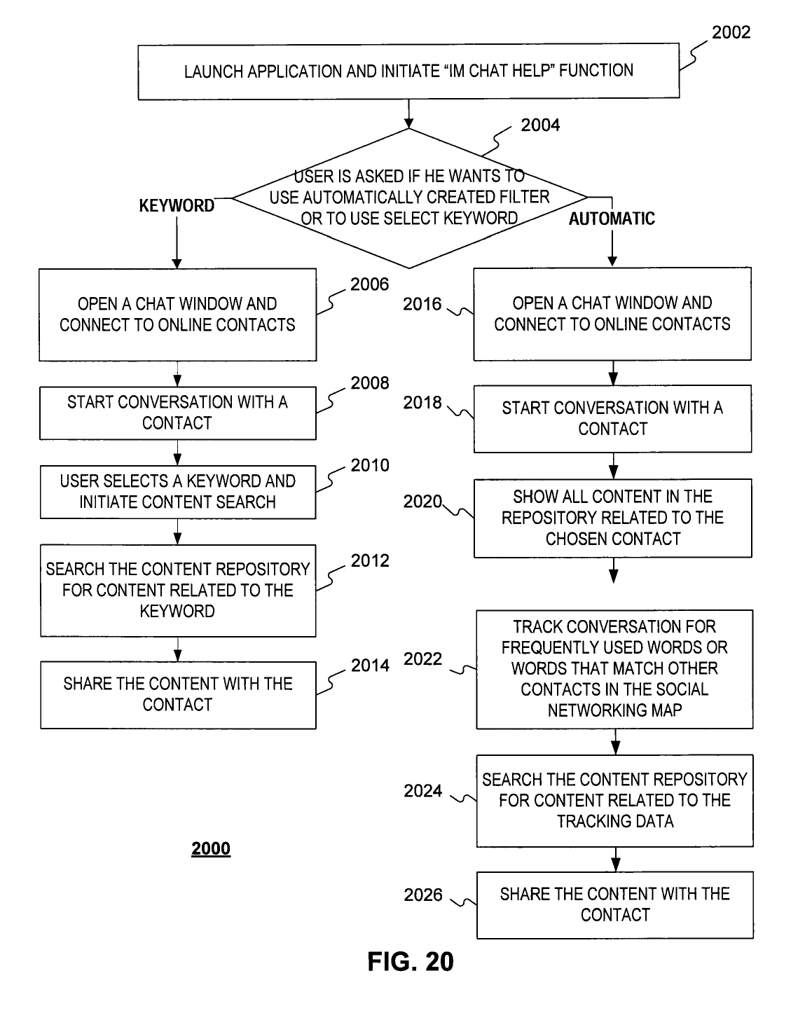

FIG. 20 is an exemplary flow chart for sharing networking content during online chatting, consistent with the present invention. Process 2000 may start when the user launches social network managing application 700 and initiates the “instant messenger (IM) chat help” function (step 2002). In step 2004, the user may be asked if he wants to use automatically created filters or to use keywords selected by his own. If the user would like to use his own keywords (step 2004: keyword), steps 2006-2014 may be performed to find networking content on the repository that is related to the user selected keywords.

In step 2006, a chat window, such as chatting interface 460, may be opened and the user may be connected to his contacts that are currently online. In some embodiments, social network managing system 100 may log onto the user's social networking sites to check who are online, and provide a list of these contacts to the user. The user may select a contact from the list and start conversations with the contact in the chat window (step 2008).

The user may select a keyword to initiate a content search on the repository (step 2010). The search may query the content repository and locate content that is related to the keyword (step 2012). In some embodiments, the content may be located by filtering the tags of the content using the user selected keyword. It is contemplated that the user may select more than one keywords, and the search may locate content that contains all the keywords. The content located during the search may be shared with the contact during the online chatting (step 2014).

If the user would like to use filters automatically created by social network managing application 700 (step 2004: automatic), steps 2016-2026 may be performed. Steps 2016 and 2018 may be performed in a similar manner as steps 2006 and 2008. In step 2020, all content that is related to the contact may be displayed to the user, e.g., via repository content display area 470. In some embodiments, a search may be performed to locate the content using the contact's name or other information as a filter.

During the online chatting session, the conversations between the user and the contact may be tracked for frequently used words (step 2022). In some embodiments, the conversations may be monitored and once a word is used for more than a threshold number of times, the word may be recorded. In some embodiments, words that match with other contacts on the social networking map may be recorded as well. For example, when the conversation mentions “John,” a friend in the user's friends tree, or “your brother,” i.e., the user's brother James, the word “John” and “brother” may be recorded as tracking data.

The search may query the content repository and locate content that is related to the tracking data (step 2024). In some embodiments, the content may be located by filtering the tags of the content using the tracking data. The content located during the search may be shared with the contact during the online chatting (step 2026).

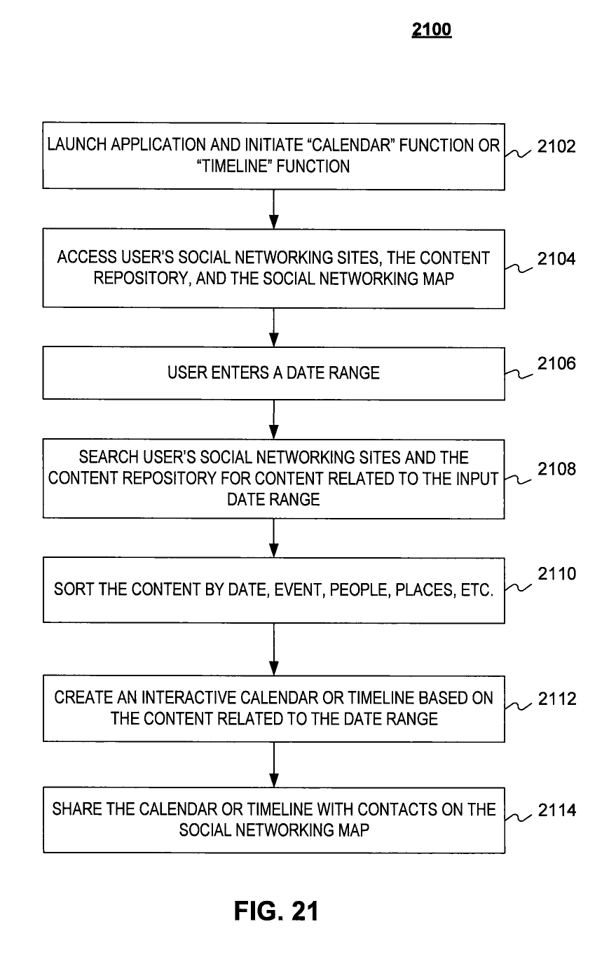

FIG. 21 is an exemplary flow chart for creating a calendar or timeline view, consistent with the present invention. Process 2100 may start when the user launches social network managing application 700 and initiates the “calendar” function or “timeline” function (step 2102). Social network managing application 700 may access the user's social networking sites using his login information, as well as content repository module 701 and the social networking map, e.g., family tree module 702 and friends tree module 703 (step 2104).

The user may enter a date range (step 2106), e.g., via user input interface 230. In some embodiments, the user may be asked to enter the starting date and ending date in the date, month and year format. In some embodiments, the user may be provided with a calendar to select the starting date and ending date of the date range. In some embodiments, the date range may be in a past time or in a future time, or partially in the past time and partially in the future time (i.e., including the current time).

Social network managing application 700 may be configured to search the user's social networking sites and the content repository for content related to the input date range (step 2108). In some embodiments, the networking content on the sites and on the repository is filtered by the date range. For example, during the search, photos with time stamps falling within the date range may be located. As another example, events that took place (if the date range is a past time) or will take place (if the date range is a future time) within the date range may be located.

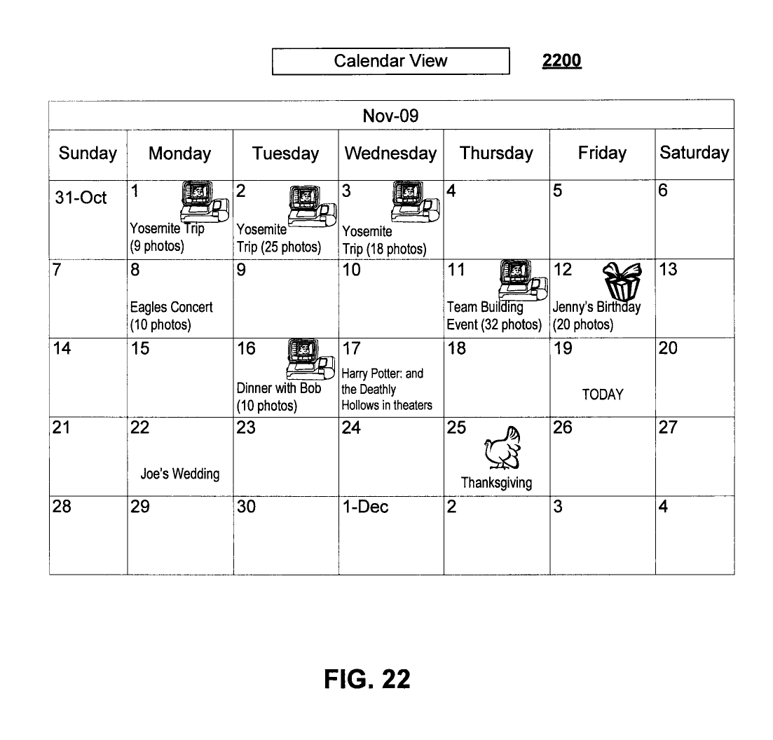

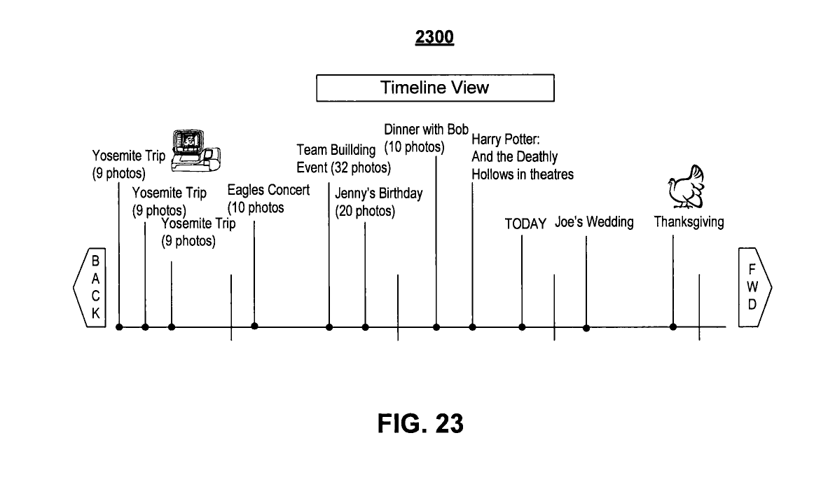

The content located in step 2108 may be sorted (step 2110). For example, the content may be sorted by date, event, people, places, etc. An interactive calendar or timeline may be created with the content related to the date range (step 2112). For example, FIG. 22 illustrates an exemplary calendar view 2200 created by the exemplary process of FIG. 21, consistent with the present invention. In some embodiments, calendar view 2200 may be displayed as a two dimensional chart. FIG. 23 illustrates an exemplary timeline view 2300 created by the exemplary process of FIG. 21, consistent with the present invention. In some embodiments, timeline view 2300 may be displayed as a one-dimensional line.

As shown in FIG. 22 and FIG. 23, a date range of Oct. 31, 2009 to Dec. 4, 2009 is included in calendar view 2200 or timeline view 2300. Part of this date range falls in the past, and part of it falls in the future. As shown in FIG. 22 and FIG. 23, “today” is Nov. 19, 2009. In some embodiments, calendar view 2200 or timeline view 2300 may be marked with events occurred or will occur during the date range. For example, Nov. 1, 2009-Nov. 3, 2009 are marked with a Yosemite trip, and Nov. 22, 2009 is marked with Joe's wedding. In some embodiments, for events that have occurred, the event dates may be additional associated with content related to the events. For example, a link to 32 photos may be provided associated with the team building event occurred on Nov. 11, 2009. In some embodiments, calendar view 2200 or timeline view 2300 may further include icons or clip arts that indicate the types of the events, as shown in FIG. 22 and FIG. 23.

The created calendar view or timeline view may be shared with contacts on the social networking map (step 2114). In some embodiments, participants to the social events included in the calendar or timeline may be identified, and the calendar view or timeline view may be shared with these participants only.

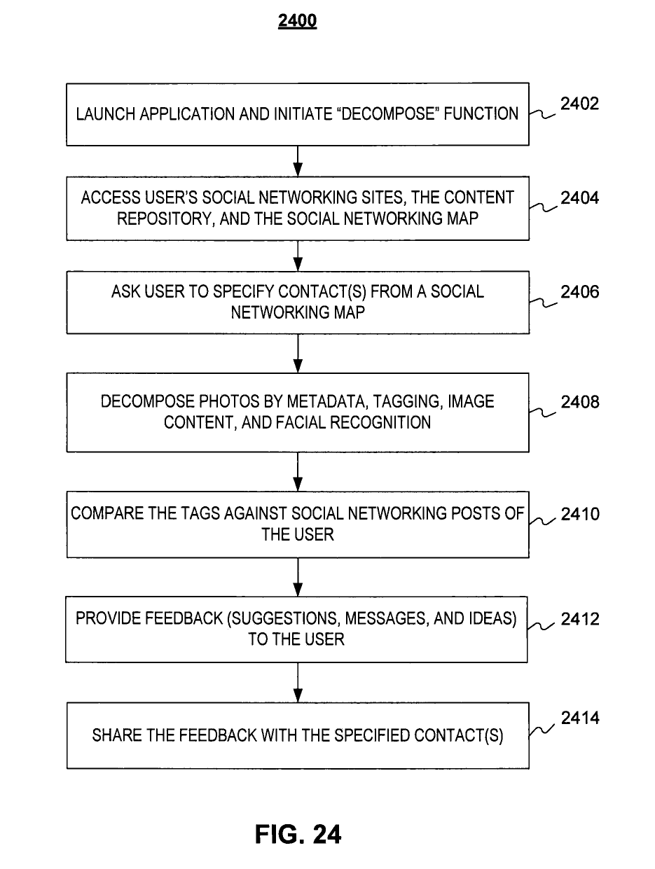

FIG. 24 is an exemplary flow chart for decomposing networking content for providing feedback, consistent with the present invention. Process 2400 may start when the user launches social network managing application 700 and initiates the “decompose” function (step 2402). Social network managing application 700 may access the user's social networking sites using his login information, as well as content repository module 701 and the social networking map, e.g., family tree module 702 and friends tree module 703 (step 2404).

Social network managing application 700 may ask the user to specify one or more contacts on the social networking map (step 2406). For example, the selection may be made on user interface 500 or user interface 600. In step 2408, networking content on the content repository, e.g., photos, may be “decomposed” by metadata, tagging, image content, and facial recognition. In some embodiments, the tags of the networking content may be sorted into groups, such as people, places, things, events, favorites, like, dislike.

In step 2410, the tags may be compared against the user's posts on the social networking sites. In some embodiments, content with a tag related to the posts may be located. The located content may be used to provide feedback, including suggestions, messages, and ideas, to the user (step 2412). In some embodiments, suggestions about locations, information on places and activities, and noteworthy places the user might find interesting, may be made to the user. In some embodiments, information on the user's friends may be determined from the located content. For example, the information may include trips with friends, email of update one year later, recipes of foods eaten at restaurants or social events, and/or miscellaneous information such as geographic or seasonal information on user's favorite locations or favorite locations of friends. In step 2414, the feedback (e.g., suggestions, messages, and ideas) may be shared with the contact specified in step 2406.

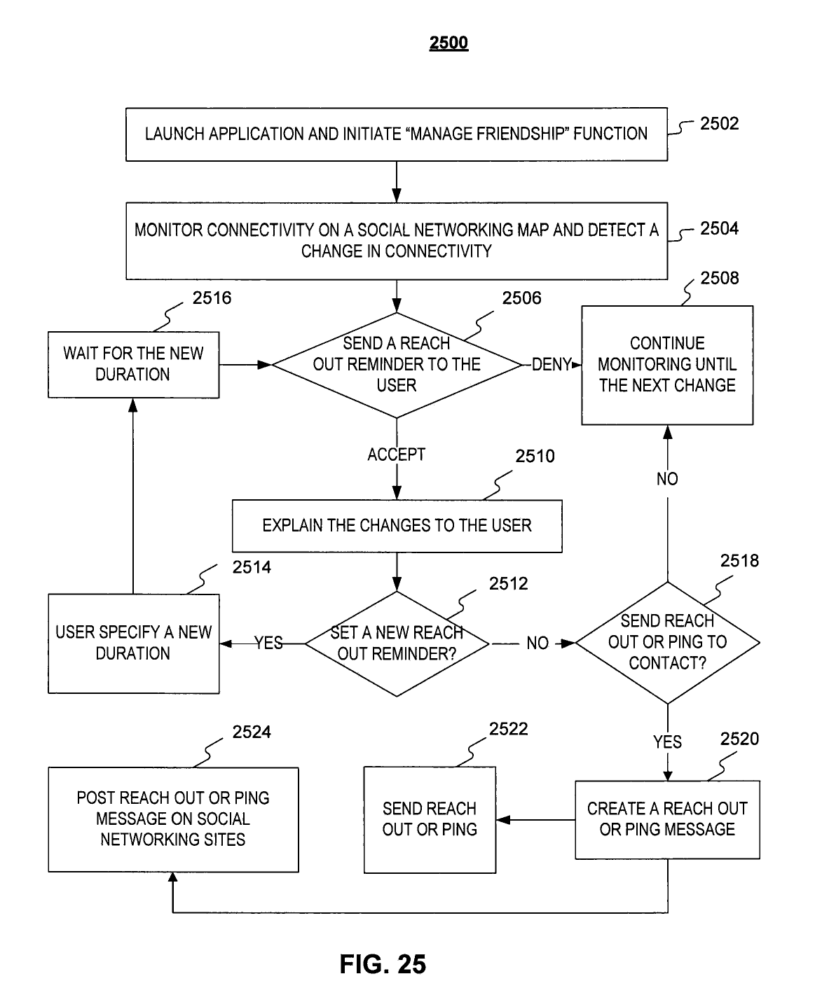

FIG. 25 is an exemplary flow chart for managing friendship using a friends tree, consistent with the present invention. Process 2500 may start when the user launches social network managing application 700 and initiates the “manage friendship” function (step 2502). Social network managing application 700 may monitor the connectivity between the user and each contact on a social networking map (step 2504). In some embodiments, a change in the connectivity may be detected. For example, when the connectivity between the user and his aunt change from “strong” to “normal,” the change may be detected. As another example, if the user has not communicated a certain contact for longer than a threshold time.

Upon detection of the change, social network managing application 700 may send a reach out reminder to the user (step 2506). For example, a reminder dialog window may be shown to the user upon launching network managing application 700. The user may be provided the options to accept or deny the reminder in step 2506. If the use denies the reminder (step 2506: deny), social network managing application 700 may continue monitor the connectivity until the next change occurs (step 2508). That is, process 2500 may return to step 2504.

If the user accepts the reminder (step 2506: accept), social network managing application 700 may explain the change to the user (step 2510). In some embodiments, the user may be provided information that the change is that the strength of connectivity between the user and a particular contact falls from “strong” to “normal,” or from “normal” to “weak.” In some other embodiments, the user may be notified that he has not communicated with a particular contact for a certain period of time.

In step 2512, the user may be asked if he wants to set a new reach out reminder. For example, the user may be asked: do you want to be reminded later? If the user chooses to set the new reminder (step 2512: yes), the user may be allowed to specify a new duration of time for receiving the next reach out reminder (step 2514). For example, the user may specify that the next reminder be sent a week later. Accordingly, social network managing application 700 may wait for the specified duration (step 2516), before another reach out reminder is sent out (step 2506).

If the user chooses not to set the new reminder (step 2512: no), the user may be asked if he wants to send a “reach out” message or a “ping” message to the contact (step 2518). If user declines (step 2518: no), process 2500 may return to step 2508 to continue monitoring the connectivity. Otherwise (step 2518: yes), a “reach out” message or a “ping” message may be created (step 2520). Consistent with this application, a “ping” message may be a short online message while a “reach out” message may contain more details. For example, the “ping” message may be as brief as “how is going?” or “long time no see,” sent through an online chatting window. A “reach out” message may be a post on the contact's networking page or an email to the contact that includes some specific information.

In some embodiments, social network managing application 700 may create a “latest status” template for the user to edit into a customized “reach out” message. For example, social network managing application 700 may review the user's old messages, photos, or other networking content for creating the template. In some embodiments, the “reach out” message may include a summary of the user's activities since the last communication. In some embodiments, the “reach out” message may include a summary of previous communications the user had with the contact.

The “reach out” message or “ping” message may be privately sent to the contact (step 2522), and/or be posted some or all of the user's social networking sites (step 2524). In some embodiments, the user may further allowed to set a “viewing filter” to limit the viewing of the message to one or more contacts.

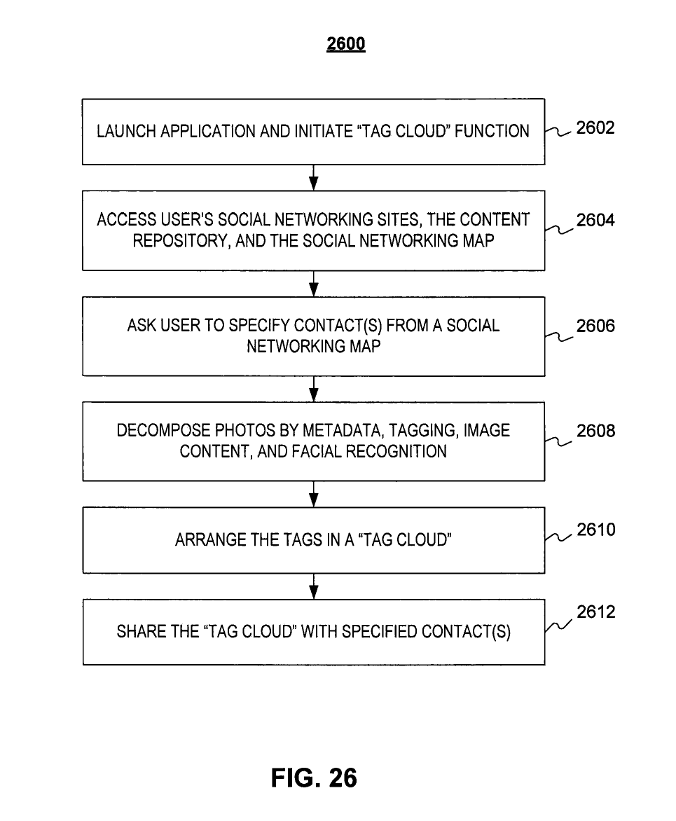

FIG. 26 is an exemplary flow chart for generating a “tag cloud”, consistent with the present invention. Process 2600 may start when the user launches social network managing application 700 and initiates the “tag cloud” function (step 2602). Social network managing application 700 may access the user's social networking sites using his login information, as well as content repository module 701 and the social networking map, e.g., family tree module 702 and friends tree module 703 (step 2604).

Social network managing application 700 may ask the user to specify one or more contacts on the social networking map (step 2606). In step 2608, networking content on the content repository, e.g., photos, may be “decomposed” by metadata, tagging, image content, and facial recognition. In some embodiments, the tags of the networking content may be sorted into groups, such as people, places, things, events, favorites, like, dislike.

The tags may be further arranged in to a “tag cloud” (step 2610). Consistent with this application, a “tag cloud” may be a organized representation of the tags. In some embodiments, the tags may be arranged such that the most common tags are shown in the largest text and the least common tags are shown in the smallest text. The “tag cloud” may be shared with the specified contacts specified in step 2606 (step 2612).

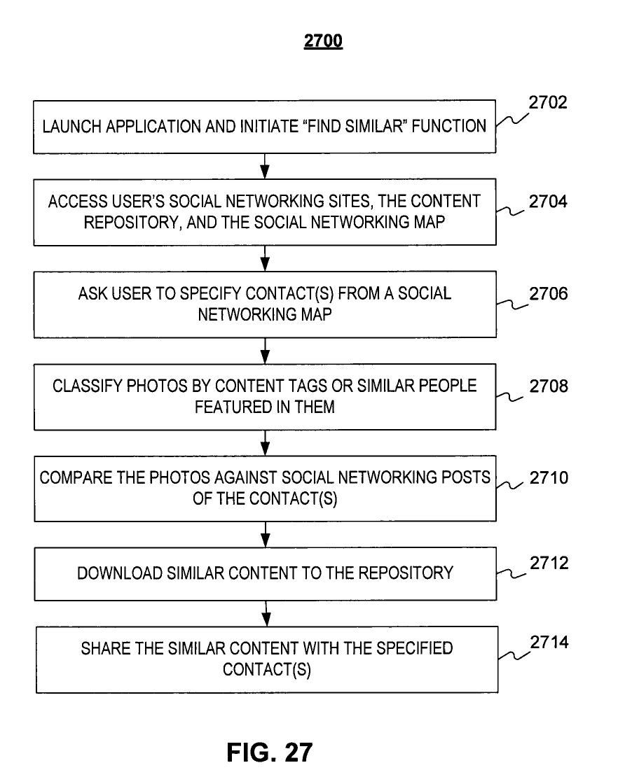

FIG. 27 is an exemplary flow chart for finding photos of a contact that are similar to photos of a user, consistent with the present invention. Process 2700 may start when the user launches social network managing application 700 and initiates the “find similar” function (step 2702). Social network managing application 700 may access the user's social networking sites using his login information, as well as content repository module 701 and the social networking map, e.g., family tree module 702 and friends tree module 703 (step 2704).

Social network managing application 700 may ask the user to specify one or more contacts on the social networking map (step 2706). In step 2708, networking content on the content repository, e.g., photos, may be classified based on the associated content tags or similar people featured in them. For example, facial recognition may be applied to the photos to determine who are featured in them.

In step 2710, the photos may be compared against the contacts' posts on the social networking sites. In some embodiments, content that is related to, in particular, similar to, the photos may be located. The located content may be downloaded and placed on the repository (step 2712). In step 2714, the content may be shared with the contact specified in step 2706.

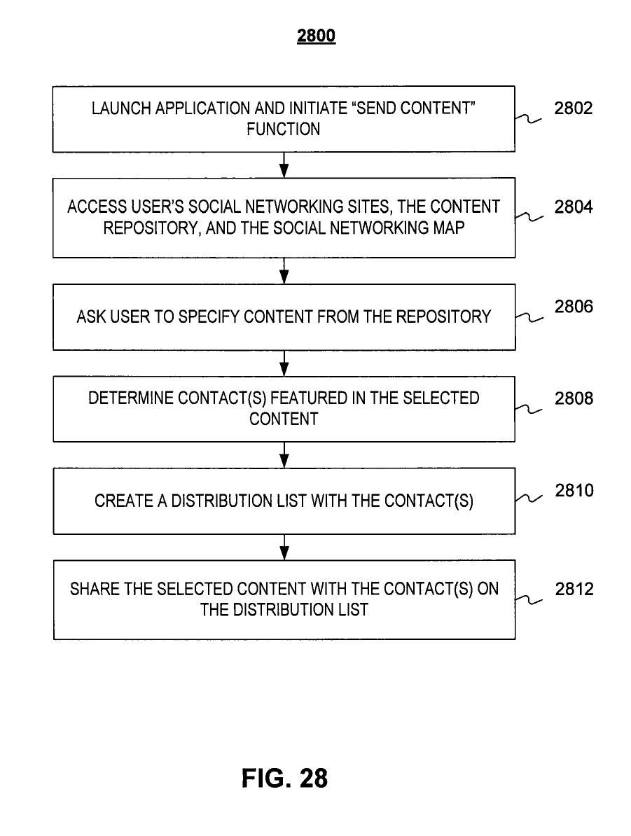

FIG. 28 is an exemplary flow chart for sharing content with contacts featured in the content, consistent with the present invention. Process 2800 may start when the user launches social network managing application 700 and initiates the “find similar” function (step 2802). Social network managing application 700 may access the user's social networking sites using his login information, as well as content repository module 701 and the social networking map, e.g., family tree module 702 and friends tree module 703 (step 2804).

Social network managing application 700 may ask the user to specify certain content on the content repository (step 2806). In some embodiments, the user may be allowed to select the content on repository content display area 470. In step 2808, social network managing application 700 may determined one or more contacts who are featured in the selected content. For example, the selected content may be a photo/video, and social network managing application 700 may use facial recognition or otherwise check its tags or metadata to determine who are in the photo/video.

In step 2810, a distribution list may be created for sharing the selected content. For example, the distribution list may include the contacts identified in step 2808. Alternatively, the distribution list may include contacts who have a strength of connectivity higher than a predetermined threshold. In some embodiments, the user may be allowed to edit the distribution list to add or remove any contacts. In step 2812, the selected content may be shared with contacts on the distribution list.

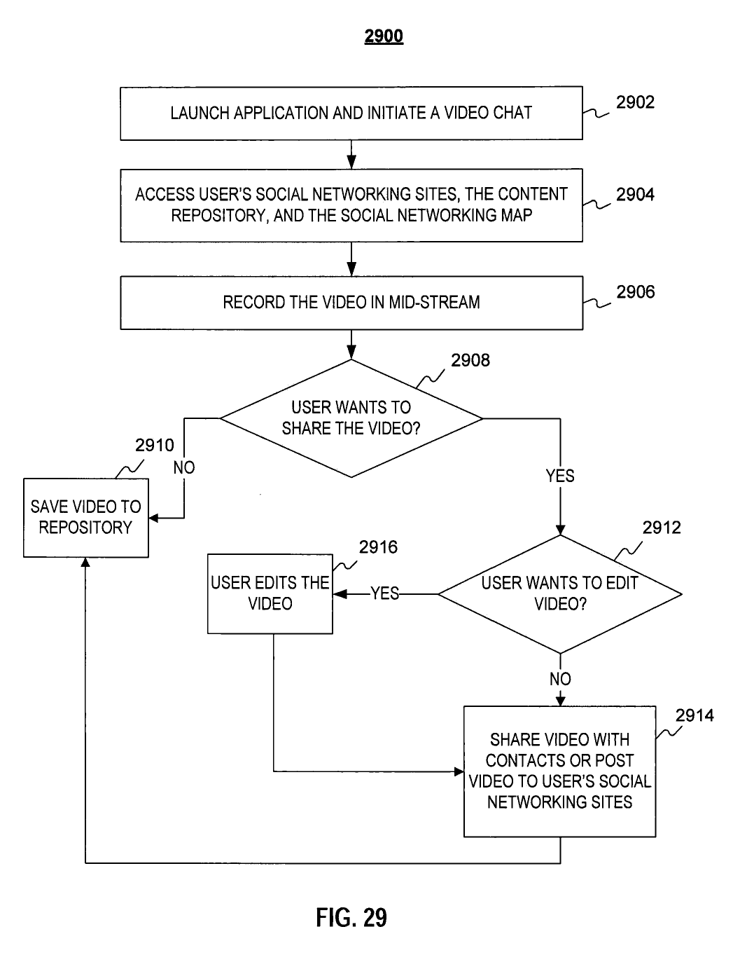

FIG. 29 is an exemplary flow chart for sharing a video recorded during online chatting using a social networking map, consistent with the present invention. Process 2900 may start when the user launches social network managing application 700 and initiates a video chat session (step 2902). Social network managing application 700 may access the user's social networking sites using his login information, as well as content repository module 701 and the social networking map, e.g., family tree module 702 and friends tree module 703 (step 2904).

During the video chat, social network managing application 700 may be configured to record the video in mid-stream (step 2906). The user may be asked if he wants to share the video with other contacts (step 2908). If the user does not want to share the video (step 2908: no), the video may be saved on the repository (step 2910), and process 2900 may terminate. If the user wants to share the video (step 2908: yes), he may be further asked if he wants to edit the video before sharing it (step 2912).

If the user chooses not to edit the video (step 2912: no), the video may be shared with contacts or posted on the user's social networking sites, without editing (step 2914). If the user prefers to edit the video (step 2912: yes), social network managing application 700 may provide an interface and necessary tools for the user to edit the video (step 2916). Accordingly, the edited video may be shared with contacts or posted on the user's social networking sites in step 2914. After sharing or posting in step 2914, the video may be saved on the repository (step 2910), and process 2900 may terminate.

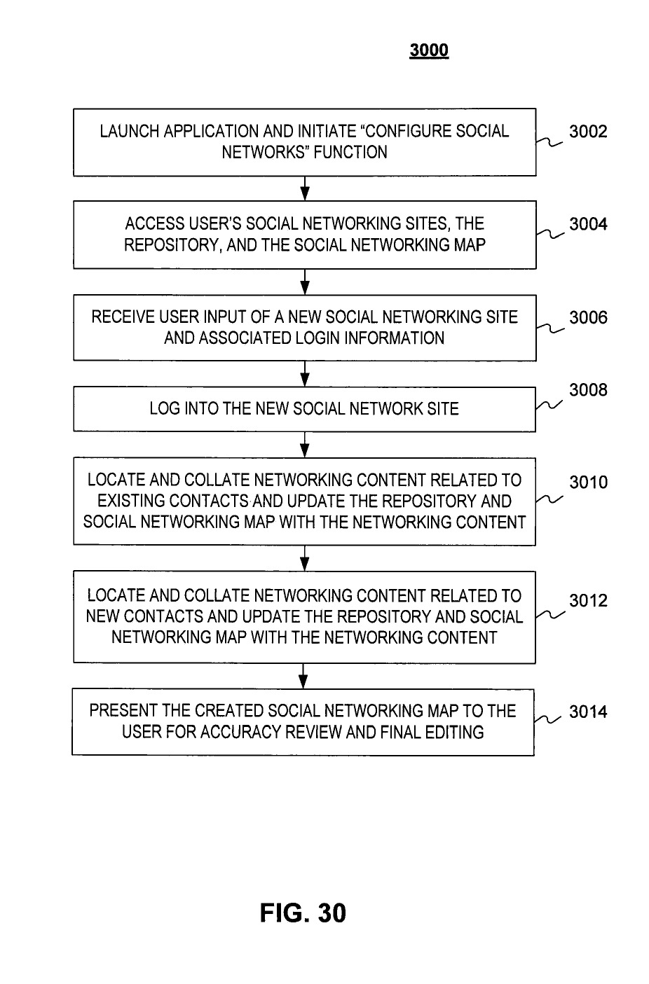

FIG. 30 is an exemplary flow chart for updating a social networking map using information from a new social network account, consistent with the present invention. Process 3000 may start when the user launches social network managing application 700 and initiates a “configure social networks” function (step 3002). Social network managing application 700 may access the user's social networking sites using his login information, as well as content repository module 701 and the social networking map, e.g., family tree module 702 and friends tree module 703 (step 3004).

In step 3006, social network managing application 700 may receive user input of a new social network site as well as the login information to the new site. For example, the user may have joined a new networking site since the last launch. In some embodiments, social network managing application 700 may check with user if he has any new social networking sites to add, upon each launch. Social network managing application 700 may log into the new social networking site using the login information (step 3008).

Networking content on the new social networking site that is related to the user's existing contacts may be located and collated (step 3010). In some embodiments, social network managing application 700 may use the contacts on the social networking map as filters to locate the content. In step 3010, the social networking map and the repository may be updated using the located networking content. Further, new contacts and their associated networking contents may also located and collated (step 3012). The social networking map may be updated to add the new contacts, and the repository may be updated to save the located networking content. The updated social networking map may be presented to the user for accuracy review and/or final editing (step 3014).

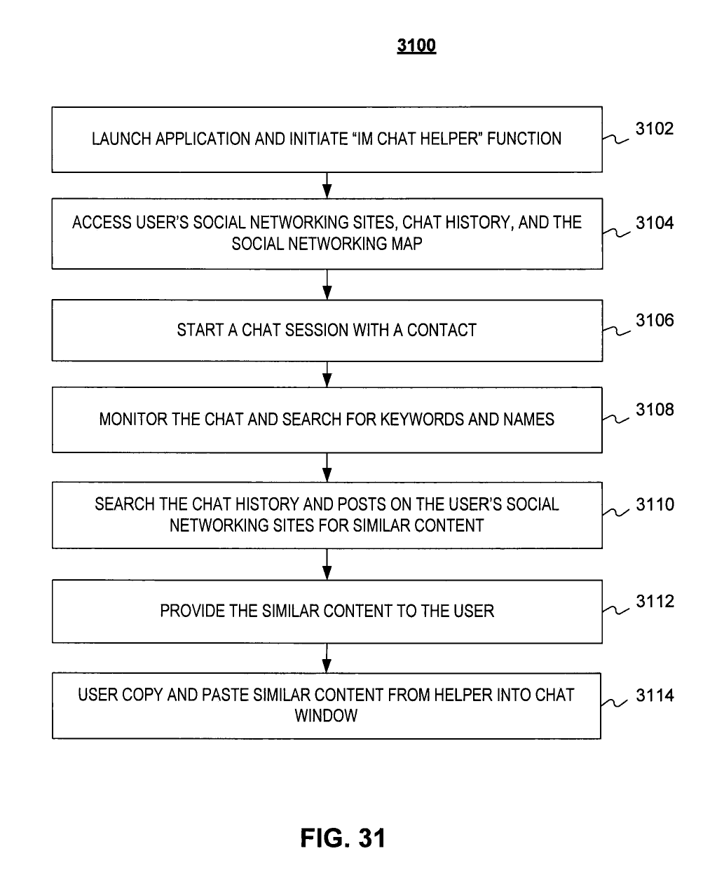

FIG. 31 is an exemplary flow chart for finding content related to online chatting using a social networking map, consistent with the present invention. Process 3100 may start when the user launches social network managing application 700 and initiates an “IM chat helper” function (step 3102). Social network managing application 700 may access the user's social networking sites using his login information, as well as the social networking map, e.g., family tree module 702 and friends tree module 703 (step 3104). In some embodiments, social network managing application 700 may also access previous chat histories on content repository module 701.

The user may start a chat session with a selected contact (step 3106). For example, the user may chat with the contact trough chatting interface 460. During the online chatting session, the conversations between the user and the contact may be monitored for keywords (step 3108). In some embodiments, a word may be recorded as a keyword if it is used for more than a threshold number of times during the conversation, such as “Hawaii,” “black Friday,” “museum,” etc. In some embodiments, the keyword may be a person's name, such as “John”.

Social network managing application 700 may search the chat histories on the content repository and posts on the user's social networking sites, and locate content that is related to the keywords (step 3110). In some embodiments, the content may be located by filtering the tags of the content using the keywords. For example, content tagged with “Hawaii” or “John” may be located. In some embodiments, the located content may include previously discussed topics, news stores from around the web, topics discussed by the user's other contacts, or conversation snippets that include the user's name or a friend's name.

The content located during the search may be provided to the user during the online chatting (step 3112). For example, the content may be shown in the IM chat helper or in content repository display area 470. The user may be allowed to copy and paste the content into the chat window, or send the content as a file to the contact (step 3114).

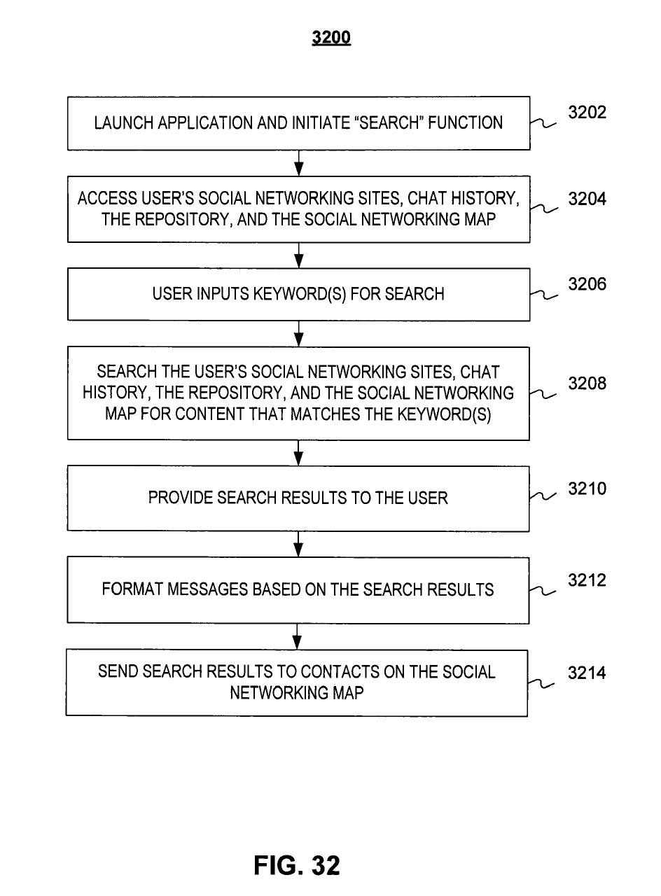

FIG. 32 is an exemplary flow chart for searching for content using a social networking map, consistent with the present invention. Process 3200 may start when the user launches social network managing application 700 and initiates a “search” function (step 3202). Social network managing application 700 may access the user's social networking sites using his login information, content repository module 701 and the chat histories stored thereon, as well as the social networking map, e.g., family tree module 702 and friends tree module 703 (step 3204).

The user may input one or more keywords for starting a search (step 3206). Social network managing application 700 may search the content repository, the user's social networking sites, and the social networking map, to locate content that is related to the keywords (step 3208). In some embodiments, the content may be located by using the keywords as filters. The content located during the search may be provided to the user (step 3210). The user may be allowed to format messages based on the located content (step 3112) and/or to send the located content to contacts on the social networking map (step 3114).

For purposes of explanation only, certain aspects and embodiments are described herein with reference to the components illustrated in FIGS. 1-32. The functionality of the illustrated components may overlap, however, and may be present in a fewer or greater number of elements and components. Further, all or part of the functionality of the illustrated elements may co-exist or be distributed among several geographically dispersed locations. Moreover, embodiments, features, aspects and principles of the present invention may be implemented in various environments and are not limited to the illustrated environments.

Further, the sequences of events described in FIGS. 1-32 are exemplary and not intended to be limiting. Thus, other method steps may be used, and even with the methods depicted in FIGS. 1-32, the particular order of events may vary without departing from the scope of the present invention. Moreover, certain steps may not be present and additional steps may be implemented in FIGS. 1-32. Also, the processes described herein are not inherently related to any particular apparatus and may be implemented by any suitable combination of components.

Other embodiments of the inventions will be apparent to those skilled in the art from consideration of the specification and practice of the inventions disclosed herein. It is intended that the specification and examples be considered as exemplary only, with a true scope and spirit of the claimed invention being indicated by the following claims.

What is claimed is:

1. A computer-implemented method for managing social networks of a user, comprising:
accessing, by a processor, an online social network site of the user;
receiving, from the online social network site, networking content related to the user and a plurality of contacts of the user;
identifying, by the processor, the plurality of contacts based on the networking content;
determining, by the processor, relationships between the user and the respective contacts based on the networking content; and
creating, by the processor, a social networking map according to the relationships.

2. The method of claim 1, further comprising:
storing the networking content in a content repository.

3. The method of claim 1, further comprising:
providing the social networking map to the user for editing.

4. The method of claim 1, wherein the networking content includes tags and metadata, and wherein determining the relationships between the user and the respective contacts includes:
sorting the networking content based on the tags and metadata.

5. The method of claim 1, wherein the networking content includes photo or video content, and wherein identifying the plurality of contacts includes:
applying facial recognition on the photo or video content.

6. The method of claim 1, further comprising:
determining strength of connectivity between the user and the respective contacts based on common connections to the networking content between the user and respective contacts.

7. The method of claim 6, wherein the social networking map is a family tree including the user and a plurality of family contacts.

8. The method of claim 6, wherein the social networking map is a friends tree including the user and a plurality of friend contacts.

9. The method of claim 2, further comprising:
receiving a search query;
determining a subset of the networking content stored on the content repository that meets the search query; and
providing the subset of the networking content to the user.

10. The method of claim 2, further comprising:
identifying a subset of the networking content stored on the content repository for sharing;
generating a distribution list including at least one contact on the social networking map; and
sharing the subset of the networking content with the at least one contact on the distribution list.

11. The method of claim 10, wherein the distribution list consists of contacts having strength of connectivity higher than a predetermined threshold.

12. The method of claim 10, wherein the distribution list consists of contacts who are featured in the identified subset of the networking content.

13. The method of claim 2, further comprising:
creating a shared account for accessing a directory of the content repository;
generating an access list including at least one contact on the social networking map; and
providing login information of the shared account to the at least one contact.

14. The method of claim 2, further comprising:
creating a dropbox on the content repository for the plurality of contacts on the social networking map to upload or download content; and
providing the plurality of contacts with access information to the dropbox.

15. The method of claim 2, further comprising:
receiving tags applied by the user on a subset of the networking content stored on the content repository;
updating the social networking map based on the tags.

16. The method of claim 2, further comprising:
detecting networking content on the content repository that have a same tag; and
merging the detected networking content into a single file.

17. The method of claim 1, further comprising:
capturing a photo or video of the user with a built-in camera; and
sharing the photo or video with the plurality of contacts on the social networking map.

18. The method of claim 2, further comprising:
receiving a keyword provided by the user during an online conversation;
identifying a subset of the networking content stored on the content repository related to the identified contact; and
providing the subset of the networking content with the user.

19. The method of claim 2, further comprising:
automatically determining a keyword based on the online conversation;
identifying a subset of the networking content stored on the content repository related to the keyword; and
providing the subset of the networking content to the user.

20. The method of claim 19, wherein the keyword is used during the online conversation for more than a threshold times or identifies a distinct contact on the social networking map.

21. The method of claim 1, further comprising:
receiving a date range input by the user;
identifying, from the networking content, social events within the date range; and
creating a calendar or timeline showing the identified social events.

22. The method of claim 21, further comprising:
identifying participants to the social events who are on the social networking map; and
sharing the calendar or timeline with the participants.

23. The method of claim 1, further comprising:
determining topics the user is interested in based on the networking content; and
providing recommended information to the user regarding the topics.

24. The method of claim 6, further comprising:
detecting a change in the strength of connectivity between the user and a contact;
sending a reach out message to the contact.

25. The method of claim 24, wherein the change is that the contact who was strongly connected becomes weakly connected.

26. The method of claim 24, wherein the change is that the user has not communicated with the contact for a period of time longer than a predetermined duration.

27. The method of claim 1, further comprising:
sorting the networking content into a plurality of groups associated with respective tags, wherein a first tag is associated with a first group and a second tag is associated with a second group larger than the first group;
generating a tag cloud with the tags, wherein the second tag is shown in a larger text than the first tag in the tag cloud.

28. The method of claim 1, further comprising:
receiving an user selection of a contact on the social networking map;
identifying networking content of the user that are similar to networking content of the contact; and
sharing the identified networking content of the user with the contact.

29. The method of claim 1, further comprising:
recording an online video chat between the user and a contact; and
sharing the online video chat with the plurality of contacts on the social networking map.

30. The method of claim 1, further comprising:
accessing an additional online social network site of the user;
locating, on the additional online social network site, additional networking content related to the plurality of contacts on the social networking map; and
updating the social networking map based on the additional networking content.

31. The method of claim 1, further comprising:
monitoring an online conversation between the user and a contact;
determining a keyword from the online conversation;
searching for online content related to the keyword; and
generating a template message based on the online content to assist the online conversation.

32. A social network managing system for managing social networks of a user, comprising:
a processor configured to:
accessing an online social network site of the user;
receiving, from the online social network site, networking content related to the user and a plurality of contacts of the user;
identifying the plurality of contacts based on the networking content;
determining relationships between the user and the respective contacts based on the networking content; and
creating a social networking map according to the relationships.

33. The social network managing system of claim 32, further comprising a memory configured to:
store the networking content in a content repository.

34. The social network managing system of claim 32, wherein the processor is further configured to:
provide the social networking map to the user for editing.

35. The social network managing system of claim 32, wherein the networking content includes tags and metadata, and wherein the processor is further configured to:
sort the networking content based on the tags and metadata.

36. The social network managing system of claim 32, wherein the networking content includes photo or video content, and wherein the processor is further configured to:
apply facial recognition on the photo or video content.

37. The social network managing system of claim 32, wherein the processor is further configured to:
determine strength of connectivity between the user and the respective contacts based on common connections to the networking content between the user and respective contacts.

38. The social network managing system of claim 37, wherein the social networking map is a family tree including the user and a plurality of family contacts.

39. The social network managing system of claim 37, wherein the social networking map is a friends tree including the user and a plurality of friend contacts.

40. The social network managing system of claim 33, wherein the processor is further configured to:
receive a search query;
determine a subset of the networking content stored on the content repository that meets the search query; and
provide the subset of the networking content to the user.

41. The social network managing system of claim 33, wherein the processor is further configured to:
identify a subset of the networking content stored on the content repository for sharing;
generate a distribution list including at least one contact on the social networking map; and
share the subset of the networking content with the at least one contact on the distribution list.

42. The social network managing system of claim 41, wherein the distribution list consists of contacts having strength of connectivity higher than a predetermined threshold.

43. The social network managing system of claim 41, wherein the distribution list consists of contacts who are featured in the identified subset of the networking content.

44. The social network managing system of claim 33, wherein the processor is further configured to:
create a shared account for accessing a directory of the content repository;
generate an access list including at least one contact on the social networking map; and
provide login information of the shared account to the at least one contact.

45. The social network managing system of claim 33, wherein the processor is further configured to:
create a dropbox on the content repository for the plurality of contacts on the social networking map to upload or download content; and
provide the plurality of contacts with access information to the dropbox.

46. The social network managing system of claim 33, wherein the processor is further configured to:
receive tags applied by the user on a subset of the networking content stored on the content repository;
update the social networking map based on the tags.

47. The social network managing system of claim 33, wherein the processor is further configured to:
detect networking content on the content repository that have a same tag; and
merge the detected networking content into a single file.

48. The social network managing system of claim 32, wherein the processor is further configured to:
capture a photo or video of the user with a built-in camera; and
share the photo or video with the plurality of contacts on the social networking map.

49. The social network managing system of claim 33, wherein the processor is further configured to:
receive a keyword provided by the user during an online conversation;
identify a subset of the networking content stored on the content repository related to the identified contact; and
provide the subset of the networking content with the user.

50. The social network managing system of claim 32, wherein the processor is further configured to:
determine a keyword based on the online conversation;
identify a subset of the networking content stored on the content repository related to the keyword; and
provide the subset of the networking content to the user.

51. The social network managing system of claim 50, wherein the keyword is used during the online conversation for more than a threshold times or identifies a distinct contact on the social networking map.

52. The social network managing system of claim 32, wherein the processor is further configured to:
receive a date range input by the user;
identify, from the networking content, social events within the date range; and
create a calendar or timeline showing the identified social events.

53. The social network managing system of claim 52, wherein the processor is further configured to:
identify participants to the social events who are on the social networking map; and
share the calendar or timeline with the participants.

54. The social network managing system of claim 32, wherein the processor is further configured to:
determine topics the user is interested in based on the networking content; and
provide recommended information to the user regarding the topics.

55. The social network managing system of claim 37, wherein the processor is further configured to:
detect a change in the strength of connectivity between the user and a contact;
send a reach out message to the contact.

56. The social network managing system of claim 55, wherein the change is that the contact who was strongly connected becomes weakly connected.

57. The social network managing system of claim 55, wherein the change is that the user has not communicated with the contact for a period of time longer than a predetermined duration.

58. The social network managing system of claim 32, wherein the processor is further configured to:
sort the networking content into a plurality of groups associated with respective tags, wherein a first tag is associated with a first group and a second tag is associated with a second group larger than the first group;
generate a tag cloud with the tags, wherein the second tag is shown in a larger text than the first tag in the tag cloud.

59. The social network managing system of claim 32, wherein the processor is further configured to:
receive an user selection of a contact on the social networking map;
identify networking content of the user that are similar to networking content of the contact; and
share the identified networking content of the user with the contact.

60. The social network managing system of claim 32, wherein the processor is further configured to:
record an online video chat between the user and a contact; and
share the online video chat with the plurality of contacts on the social networking map.

61. The social network managing system of claim 32, wherein the processor is further configured to:
access an additional online social network site of the user;
locate, on the additional online social network site, additional networking content related to the plurality of contacts on the social networking map; and
updating the social networking map based on the additional networking content.

62. The social network managing system of claim 32, wherein the processor is further configured to:
monitor an online conversation between the user and a contact;
determine a keyword from the online conversation;
search for online content related to the keyword; and
generate a template message based on the online content to assist the online conversation.

63. A non-transitory computer-readable storage device that stores a set of instructions which, when executed by a processor, perform a method for managing social networks of a user, comprising:
accessing, by a processor, an online social network site of the user;
receiving, from the online social network site, networking content related to the user and a plurality of contacts of the user;
identifying, by the processor, the plurality of contacts based on the networking content;
determining, by the processor, relationships between the user and the respective contacts based on the networking content; and
creating, by the processor, a social networking map according to the relationships.
